(19) United States
(12) Patent Application Publication
(10) Pub. No.: US 2007/0081282 A1
(43) Pub. Date: Apr. 12, 2007

(54) ELECTROSTATIC DISCHARGE (ESD) PROTECTION APPARATUS FOR PROGRAMMABLE DEVICE

(76) Inventors: Yan-Nan Li, Taipei County (TW); Chyh-Yih Chang, Taipei County (TW); Chun-Ming Wu, Taipei County (TW); Chin-Huang Lai, Taipei County (TW); Wen-Pin Chou, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,310

(22) Filed: Mar. 16, 2006

(30) Foreign Application Priority Data
Oct. 6, 2005 (TW) 94134934

(51) Int. Cl. H02H 9/00

(52) U.S. Cl. 361/56

(57) ABSTRACT

An electrostatic discharge (ESD) protection apparatus for programmable device is provided. This ESD protection device provides a high impedance along the electrical path from the pad to the power system for preventing the programmable device from damages induced by ESD event; and the impedance can be intentionally decreased during the normal reading and writing operations.

### CROSS-REFERENCE TO RELATED APPLICATION

This application claims the priority benefit of Taiwan application serial no. 94134934, filed on Oct. 6, 2005. All disclosure of the Taiwan application is incorporated herein by reference.

### BACKGROUND OF THE INVENTION

1. Field of Invention

The present invention relates to an electrostatic discharge (ESD) protection apparatus. More particularly, the present invention relates to an ESD protection apparatus for programmable device.

2. Description of Related Art

The programmable devices, such as the IC fuse trim cell, are often used in many integrated circuit products which requires permanent programming, so that the integrated circuit after fabrication can be trimmed according to the different demands for applications. For example, the data of the reference voltage or a plurality of digital circuits parameter data and one time programmable memory data of the analog to digital converter, digital to analog converter, and voltage control oscillator are recorded. The design concept of the programmable device is to ensure the data stored inside to be read correctly. Therefore, the techniques for preventing the programmable device from damages induced by the ESD play an important role.

The conventional polysilicon fuse trim cell is disclosed in U.S. Pat. No. 6,654,304, as shown in FIG. 1. A fuse F1 of polysilicon and a transistor MN0 are connected with each other in series at a node 10, and between a plurality of power rails VDD and GND. Due to a control signal TRIM (buffered by one or more inverters U1 and U2), the amount of the current driven by the transistor MN0 is enough to blow the fuse F1, thus resulting in an open circuit. A current source circuit 12 is made of a transistor MN1 connected to the node 10 and a low current I1 (about 2-5 μA) is provided according to a biasing voltage VB. The logic level of the node 10 is inverted by the inverter U3 and it is then outputted as an output OUT of the trim cell. In this operation, when the fuse F1 is not blown, the current (11) is flowed through the fuse F1 to cause a low voltage drop between two ends of the fuse F1, and the node 10 is made approximately equal to the voltage VDD (high level). Therefore, the inverter U3 outputs the low logic level as the output OUT of the trim cell. When the fuse F1 is blown due to the control signal TRIM, the level of the node 10 is pulled down by the current I1 to the voltage GND (a low level), thus resulting in a high level of the output OUT. At this point, the state of the output OUT is programmed based upon whether the fuse F1 is blown. However, the fuse F1 in FIG. 1 is not protected by the ESD protection circuit, and thus damages due to electrostatic discharge cannot be prevented.

Another conventional programmable device circuit is provided in U.S. Pat. No. 6,157,241, which is shown in FIG. 2. In FIG. 2, one end of a programmable fuse element 22 is coupled to a pad 24, and the other end is coupled to a ground voltage wire 26 directly. Therefore, the programmable fuse element 22 is easily damaged during the ESD events. Usually, a fuse made of polysilicon allows for several microamperes of current. However, a current of about 1.3 amperes, which is beyond the current range allowed by the polysilicon fuse, is caused in a human body model ESD (about 2 kV voltage). Once the ESD has occurred, the programmable fuse element 22 is easily damaged without having any protection by the ESD protection circuit.

Usually, the fuse is blown by electrical means or optical means. However, the energy resulted from the techniques for blowing the fuse can cause the damages of Electrical Overstress (EOS) or ESD to the circuit for reading the state of the fuse. A fault-tolerance fuse network including a fuse 301, a receiver circuit 302, a plurality of N-type transistors 304, 308, a P-type transistor 306, and a plurality of control circuits 310 and 312 is disclosed in U.S. Pat. No. 6,762,918 as shown in FIG. 3. Both ends of the fuse 301 are connected to the ground potential and the N-type transistors 304, 308, respectively. The N-type transistor 304 is coupled to the P-type transistor 306 and the receiver circuit 302. If the fuse 301 is not blown, the input end of the N-type transistor 304 is pulled down to a low level by the output end of the fuse 301. If the N-type transistor 304 is conducted, the input end of the receiver circuit 302 is pulled down by the fuse 301, so that a high level is formed at the output end 314. If the fuse 301 is blown, a lower level is formed at the output end 314. A plurality of control circuit devices 312, 310, 308 and 306 that are additional are used for determining and changing the state of the fuse 301. The N-type transistor 308 controlled by the control circuit 310 is grounded to determine the state of the fuse 301. The control circuit 312 and the P-type transistor 306 are used to pull up the input end of the receiver circuit 302.

The fuse network in FIG. 3 shall lead to a reading error of the fuse state due to EOS and ESD. For example, when secondary breakdown is induced to the N-type transistor 308 of field effect due to electrostatic discharge, a low potential is produced at the coupling end of the N-type transistor 304 of field effect, and thus an error of the output level at the output end is induced, and the state of the fuse 301 cannot be correctly determined.

Another fuse circuit system is provided in U.S. Pat. No. 6,762,918 as shown in FIG. 4, which has overcomed the deficiencies in FIG. 3. One end of a fuse 401 is coupled to the ground end and the other end is coupled to the internal network and two ESD protection devices 414, 416. The capability of the fuse circuit for ESD protection is improved dramatically. But a larger chip area is required, and the damages to the fuse 401 produced by the electrostatic discharge produced by the ground end VSS cannot be prevented.

Another fuse circuit system is provided in U.S. Pat. No. 6,469,884 as shown in FIG. 5, and no further details shall be given. The main object of the conventional art is to protect the fuse by cutting off the programmable circuit rapidly before the fuse is blown by the ESD. However, no ESD protection device is provided for protecting along the electrical path at both ends of the programmable device 501 in FIG. 5.

Another fuse circuit system is provided in U.S. Pat. No. 6,882,214 as shown in FIG. 6, and no further details shall be given. In FIG. 6, a metal fuse 621, a supply resistance 623, and an isolation diode 622 are used for the electrical isolation of the overload and the EOS state of the input pin. However, no ESD protection device is provided for protecting along the electrical path of the programmable device in FIG. 6.

The US patents described above are all described in detail in the original text. The present specification is only to illustrate the ESD protection method for the programmable device, and the original text should be referred to for the rest of the related contents which are omitted herein.

In view of the above, the programmable device in the integrated circuit (such as a fuse) is easily damaged due to ESD. Therefore, the reliability of the integrated circuit having the programmable device is reduced without ESD protection circuit.

### SUMMARY OF THE INVENTION

An object of the present invention is to provide an ESD protection apparatus for the programmable device for preventing the programmable device (such as a fuse) from damages induced by ESD events.

Another object of the present invention is to provide an ESD protection apparatus for the programmable device, and to provide another embodiment according to the spirit of the present invention for achieving the objects described above.

Still another object of the present invention is to provide an ESD protection apparatus for the programmable device, and to provide yet another embodiment according to the spirit of the present invention for achieving the objects described above.

Based on the objects described above and other objects, the present invention provides an ESD protection apparatus for the programmable device, including a first circuit, an ESD protection unit, a second circuit, a programmable device, and a third circuit. The first end of the first circuit is electrically connected to the first node. The first end of the ESD protection unit is electrically connected to the second end of the first circuit. The first end of the second circuit is electrically connected to the second end of the ESD protection unit. The programmable device is used for recording the programming results, in which the first end of the programmable device is electrically connected to the second end of the second circuit. The first and second ends of the third circuit are electrically connected to the second end of the programmable device and the second node, respectively. The programmable device is programmed using the first, second, and third circuits, and/or the programming results of the programmable device are obtained by the first, second, and third circuits. When the ESD has occurred, the ESD protection unit provides a high impedance for preventing the programmable device from damages induced by the electrostatic discharge.

From another perspective, the present invention provides an ESD protection apparatus for the programmable device, including a fifth circuit, a programmable device, an ESD protection unit, and a sixth circuit. The first end of the fifth circuit is electrically connected to the first node. The programmable device is used for recording the programming result, in which the first end of the programmable device is electrically connected to the second end of the fifth circuit. The first end of the ESD protection unit is electrically connected to the second end of the programmable device. The first and second ends of the sixth circuit are electrically connected to the second end of the ESD protection unit and the second node, respectively. The programmable device is programmed by the fifth and sixth circuits, and/or the programming results of the programmable device are obtained by the fifth and sixth circuits. When the ESD has occurred, the ESD protection unit provides a high impedance for preventing the programmable device from damages induced by the electrostatic discharge.

The present invention further provides another ESD protection apparatus for the programmable device, including an eighth circuit, a ninth circuit, a first ESD protection unit, a second ESD protection unit, and a programmable device. The first end of the eighth circuit is electrically connected to the first node. The first end of the first ESD protection unit is electrically connected to the second end of the eighth circuit. The programmable device is used for recording the programming results, in which the first end of the programmable device is electrically connected to the second end of the first ESD protection unit. The first end of the second ESD protection unit is electrically connected to the second end of the programmable device. The first and second ends of the ninth circuit are electrically connected to the second end of the second ESD protection unit and the second node, respectively. The programmable device is programmed by the eighth and ninth circuits, and/or the programming results of the programmable device are obtained by the eighth and ninth circuits. When the ESD has occurred, the first and second ESD protection units provide a high impedance for preventing the programmable device from the damages induced by the electrostatic discharge.

Since a high impedance is properly provided along the electrical path from the pad to the power system through the programmable device in the ESD protection unit of the present invention, the programmable device is prevented from the damages induced by the ESD event. During normal reading and writing operations, the impedance of the ESD protection unit is able to be reduced.

In order to the make the aforementioned and other objects, features and advantages of the present invention comprehensible, a plurality of embodiments accompanied with figures are described in detail below.

### BRIEF DESCRIPTION OF THE DRAWINGS

FIG. 1 is a circuit diagram taken from the U.S. Pat. No. 6,654,304;

FIG. 2 is a circuit diagram taken from the U.S. Pat. No. 6,157,241;

FIG. 3 is a circuit diagram 1 taken from the U.S. Pat. No. 6,762,918;

FIG. 4 is another circuit diagram taken from the U.S. Pat. No. 6,762,918;

FIG. 5 is a circuit diagram taken from the U.S. Pat. No. 6,469,884;

FIG. 6 is a circuit diagram taken from the U.S. Pat. No. 6,882,214;

FIG. 7 is a block diagram of an ESD protection apparatus for a programmable device according to an embodiment of the present invention;

FIG. 8 is a block diagram of an ESD protection apparatus for the programmable device according to another embodiment of the present invention;

FIG. 9 is a block diagram of an ESD protection apparatus for the programmable device according to yet another embodiment of the present invention;

FIGS. 10A-19D illustrate a plurality of embodiments of the ESD protection apparatus in FIG. 7 according to the present invention, respectively;

FIGS. 20A-25D illustrate a plurality of embodiments of the ESD protection apparatus in FIG. 8 according to the present invention, respectively;

FIGS. 26A-28D illustrate a plurality of embodiments of the ESD protection apparatus in FIG. 9 according to the present invention, respectively; and

FIG. 29 illustrates a circuit diagram of yet another embodiment of the ESD protection apparatus in the FIG. 7 according to the present invention.

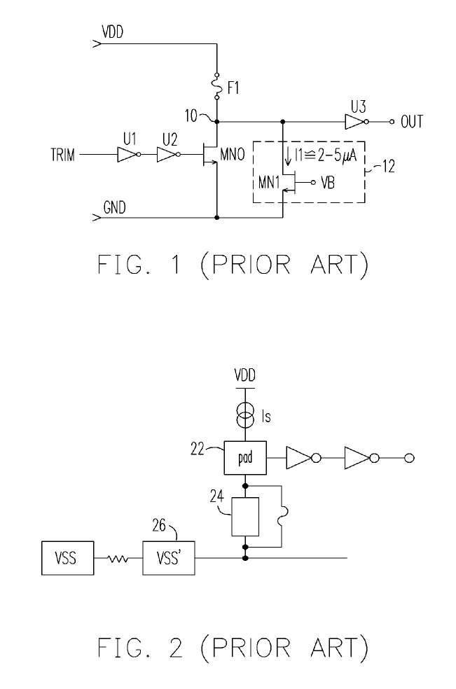

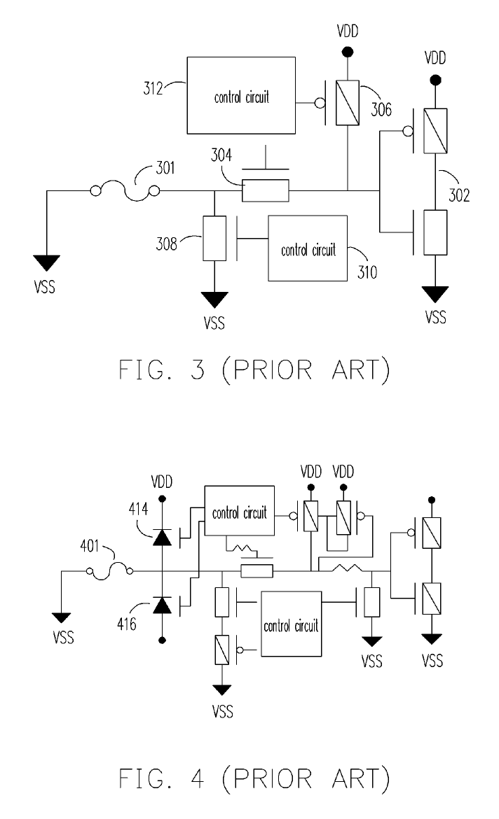

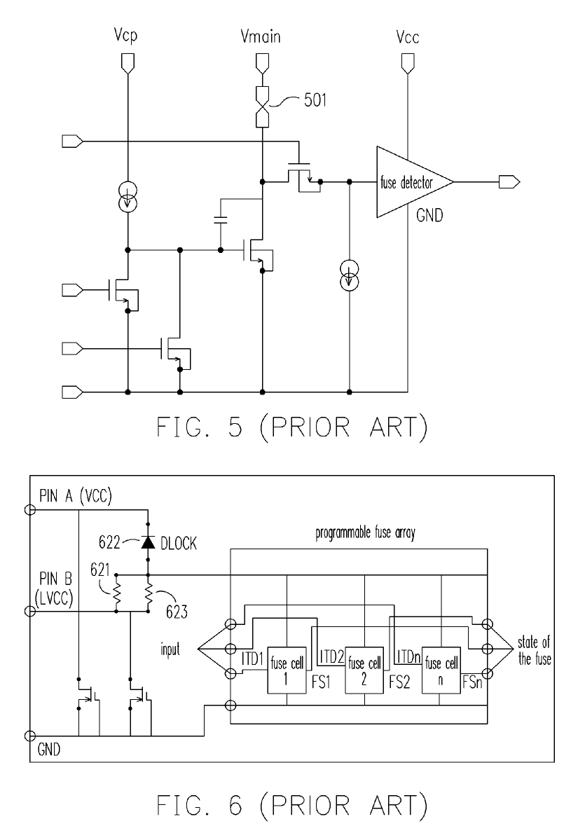

### DESCRIPTION OF THE EMBODIMENTS

A plurality of embodiments of a plurality of ESD protection apparatuses according to the present invention for preventing the programmable device from the damages induced by the ESD event shall be illustrated as follows: a proper high impedance is provided by the ESD protection apparatus, and the programmable device is prevented from the damages induced by the ESD event by reducing the voltage drop between both ends of the programmable device (such as a fuse). During the normal reading and writing operation, the impedance of the ESD protection unit can be reduced by changing the state of the control circuit.

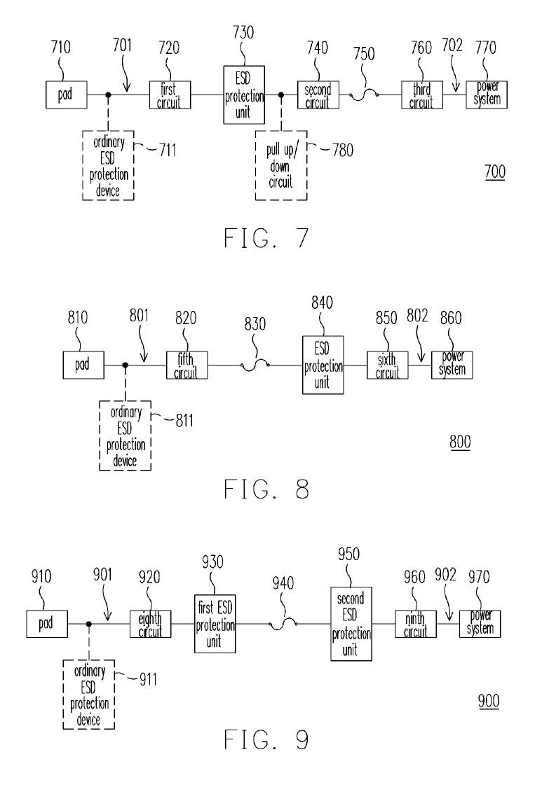

FIG. 7 is a block diagram of an ESD protection apparatus for a programmable device according to an embodiment of the present invention. Referring to FIG. 7, the ESD protection apparatus 700 includes a first circuit 720, an ESD protection unit 730, a second circuit 740, a programmable device 750, and a third circuit 760. The first and second ends of the first circuit are electrically connected to a first node 701 and the first end of the ESD protection unit 730, respectively. The first and second ends of the second circuit 740 are electrically connected to the second end of the ESD protection unit 730 and the first end of the programmable device 750, respectively. The programmable device 750 is used for recording the programming results. The first and second ends of the third circuit 760 are electrically connected to the second end of the programmable device 750 and a second node 702, respectively. The programmable device 750 is programmed using the first circuit 720, the second circuit 740, and/or the third circuit 760. And/or the programming results are obtained using the first circuit 720, the second circuit 740, and/or the third circuit 760. In the present embodiment, a pull up/down circuit 780 can be designed to couple with the second end of the ESD protection unit 730 as required. Furthermore, in the present invention, the first node 701 and the second node 702 are electrically connected to a pad 710 and a power system 770, respectively.

The power system 770 is decided to be a power voltage wire, a ground voltage wire, or something else as required by the designer. Generally, a conventional ESD protection device 711 is disposed at the pad 710 in the design of the pad 710, in which the conventional ESD protection device 711 is coupled to the pad 710 (i.e. the first node 701). When the ESD has occurred, a high impedance can be provided by the ESD protection unit 730 for reducing the voltage drop between both ends of the programmable device 750, so that the programmable device 750 is protected from damages induced by the ESD event. Certainly, the electrostatic discharge can be dissipated via the conventional ESD protection device 711, so as to reduce the electrostatic discharge which is flowed through the programmable device 750.

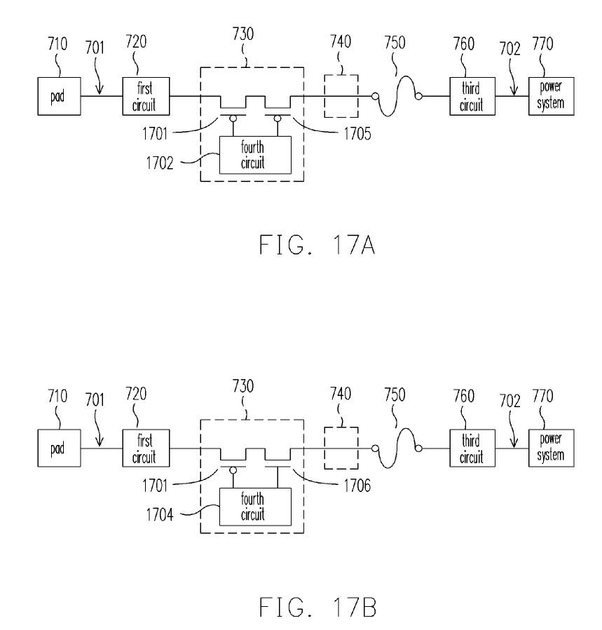

FIGS. 10A-19D illustrate a plurality of embodiments of the ESD protection apparatus 700 in FIG. 7 according to the present invention, respectively. Referring to FIG. 10A, in the present embodiment, the first circuit 720 and the third circuit 760 are implemented by the wire lead. The ESD protection unit 730 is implemented by the first transistor (referred herein as a P-type transistor) 1001 and the fourth circuit 1002. And the programmable device 750 is implemented by the fuse. The programmable device 750 is programmed by the second circuit 740, for example, whether the fuse should be blown is determined. Alternatively, the state of the programmable device 750 is read by the second circuit 740. The functions of the second circuit 740 can be achieved by any means for those skilled in the art, and therefore the embodiment of the second circuit 740 is not illustrated herein. The first transistor 1001 is used as an ESD protection device with its gate connected to the fourth circuit 1002 and with its source and drain connected to the pad 710 and the second circuit 740, respectively.

During the reading operation, the voltage drop between both ends of the programmable device 750 is sensed by the second circuit 740. If the programmable device 750 is blown, the detected voltage is surely not equal to the level of the power system 770 (such as the ground voltage). If the programmable device 750 is not blown, the detected voltage is surely close to the level of the power system 770. And then, the second circuit 740 supplies the detected voltage to the secondary circuit, and the reading operation is completed.

During the “blowing” operation, the external voltage is supplied to the programmable device 750 via the pad 710, and the first transistor 1001 is conducted through the control of the fourth circuit 1002. Meanwhile, the second circuit 740 is also conducted in preparation for the writing operation. Both the second circuit 740 and the first transistor 1001 provide for the low impedances, so that a current path is formed from the pad 710 to the power system 770. Heat is produced when the current is flowed through the programmable device 750, and therefore the programmable device 750 is programmed as expected by blowing the wire.

During the ESD event, a high impedance is provided by the first transistor 1001 to the current path from the pad 710 to the power system 770. Since the first transistor 1001 is connected in the current path in series, the electrostatic discharge voltage is divided by the supplied high impedance. Therefore, the energy passed through the programmable device 750 resulting from the ESD event can be reduced, so that the energy is lower than the voltage required by the “blowing” operation of the programmable device 750. Therefore, the programmable device 750 is able to maintain its original state, and the accuracy of the data stored therein is ensured.

The functions of the fourth circuit 1002 described above can be achieved by any means. For example, the fourth circuit 1002 is implemented by the first wire lead; and both ends of the first wire lead are connected to the gate and the ground voltage wire of the first transistor 1001, respectively. Furthermore, the implementation of the ESD protection unit 730 is not limited to the method described above. FIG. 10B illustrates another embodiment of the ESD protection apparatus 700 according to the present invention. FIG. 10B is similar to FIG. 10A, and the difference resides in the first transistor 1003 implementing using the N-type transistor in the ESD protection unit 730 of FIG. 10B. The functions of the fourth circuit 1004 can be achieved by any means. For example, the fourth circuit 1004 is implemented by the first wire lead, and both ends of the first wire lead are connected to the gate and the power voltage wire of the first transistor 1003, respectively. Being controlled by the fourth circuit, the first transistor 1003 is conducted during the “blowing” operation, and the first transistor 1003 provides a high impedance during the ESD event.

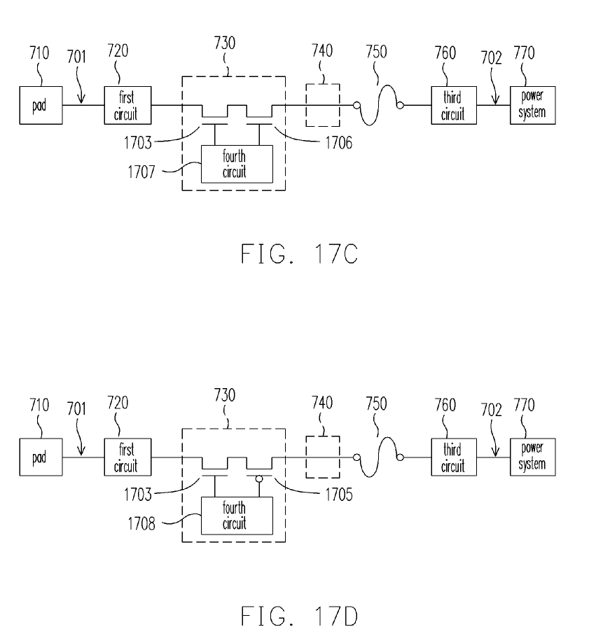

FIG. 11A illustrates another embodiment of the ESD protection apparatus 700 in FIG. 7 according to the present invention. Referring to FIG. 11A, the first circuit 720 and the second circuit 740 are implemented by wire leads. And the ESD protection unit 730 is implemented by the first transistor (referred here as the P-type transistor) 1101 and the fourth circuit 1102. In addition, the programmable device 750 is implemented by the fuse. The first transistor 1101 is used as an ESD protection device with its gate connected to the fourth circuit 1102 and its source and drain connected to the pad 710 and the programmable device 750, respectively.

During the “blowing” operation, the external voltage is supplied to the programmable device 750 via the pad 710, and the first transistor 1101 is conducted through the control of the fourth circuit 1102. Meanwhile, the third circuit 760 is also conducted in preparation for the writing operation. Both the third circuit 760 and the first transistor 1101 provide low impedances, so that a current path is formed from the pad 710 to the power system 770. Heat is produced when the current is flowed through the programmable device 750. Therefore the programmable device 750 is programmed as expected by blowing the wire. The functions of the third circuit 760 can be achieved by any means for those skilled in the art, and therefore the embodiments for implementing the third circuit 760 are not illustrated herein.

During the ESD event, the first transistor 1101 provides a high impedance to the current path from the pad 710 to power system 770. Since the first transistor 1101 is connected in the current path in series, the energy passed through the programmable device 750 resulting from the ESD event can be reduced, so that the energy is lower than the voltage required by the “blowing” operation of the programmable device 750. Therefore, the programmable device 750 is able to maintain its original state, and the accuracy of the data stored therein is ensured.

The functions of the fourth circuit 1102 described above can be achieved by any means. For example, the fourth circuit 1102 is implemented by the first wire lead; and both ends of the first wire lead are connected to the gate and the ground voltage wire of the first transistor 1101, respectively. Furthermore, the implementation of the ESD protection unit 730 is not limited to the method described above. FIG. 11B illustrates another embodiment of the ESD protection apparatus 700 according to the present invention. FIG. 11B is similar to FIG. 11A, and the difference resides in the first transistor 1103 implementing the N-type transistor in the ESD protection unit 730 of FIG. 11B. The functions of the fourth circuit 1104 can be achieved by any means. For example, the fourth circuit 1104 is implemented by the first wire lead; and both ends of the first wire lead are connected to the gate and the power voltage wire of the first transistor 1103, respectively. Being controlled by the fourth circuit, the first transistor 1103 is conducted during the “blowing” operation, and the first transistor 1103 provides a high impedance during the ESD event.

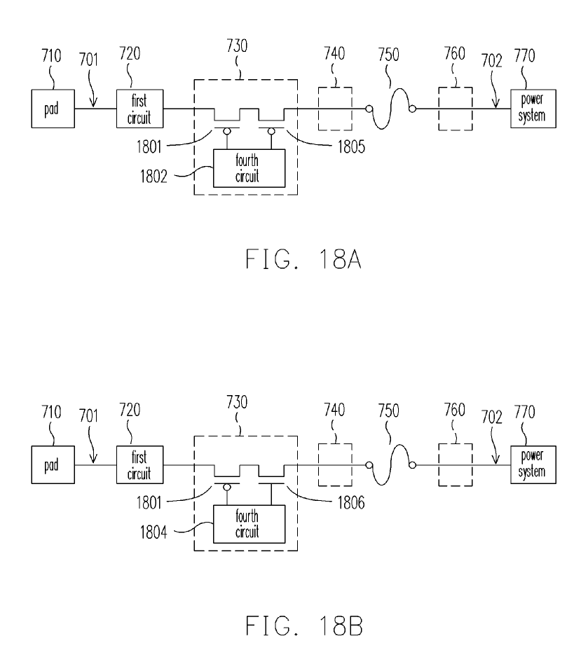

FIG. 12A illustrates another embodiment of the ESD protection apparatus 700 in FIG. 7 according to the present invention. Referring to FIG. 12A, the first circuit 720 and the second circuit 740 are implemented by wire leads, and the ESD protection unit 730 is implemented by the first transistor (here referred as the P-type transistor) 1201 and the fourth circuit 1202. And the programmable device 750 is implemented by the fuse. The first transistor 1201 is used as an ESD protection device with its gate connected to the fourth circuit 1202 and its source and drain connected to the pad 710 and the programmable device 750, respectively. Generally, a conventional ESD protection device 711 is usually disposed at the pad 710 in the design of the pad 710, in which the conventional ESD protection device 711 is coupled to the pad 710 (i.e. the first node 701).

During the “blowing” operation, the external voltage is supplied to the programmable device 750 via the pad 710, and the first transistor 1201 is conducted through the control of the fourth circuit 1202. Meanwhile, the third circuit 760 is also conducted in preparation for the writing operation. Both the third circuit 760 and the first transistor 1201 provide low impedances, so that a current path is formed from the pad 710 to the power system 770. Heat is produced when the current is flowed through the programmable device 750, and therefore the programmable device 750 is programmed as expected by blowing the wire. The functions of the third circuit 760 can be achieved by any means for those skilled in the art, and therefore the embodiments for implementing the third circuit 760 are not illustrated herein.

During the ESD event, the first transistor 1201 provides a high impedance to the current path from the pad 710 to power system 770. Since the first transistor 1201 is connected in the current path in series, the energy passed through the programmable device 750 resulting from the ESD event can be reduced, so that the energy is lower than the voltage required by the “blowing” operation of the programmable device 750. Furthermore, the electrostatic discharge can be dissipated via the conventional ESD protection device 711, so as to reduce the electrostatic discharge which is flowed through the programmable device 750. Therefore, the programmable device 750 is able to maintain its original state, and the accuracy of the data stored therein is ensured.

The functions of the fourth circuit 1202 described above can be achieved by any means. For example, the fourth circuit 1202 is implemented by the first wire lead, and both ends of the first wire lead are connected to the gate and the ground voltage wire of the first transistor 1201, respectively. Furthermore, the implementation of the ESD protection unit 730 is not limited to the method described above. FIG. 12B illustrates another embodiment of the ESD protection apparatus 700 according to the present invention. FIG. 12B is similar to FIG. 12A, and the difference resides in the first transistor 1203 implementing the N-type transistor in the ESD protection unit 730 of FIG. 12B. The functions of the fourth circuit 1204 can be achieved by any means. For example, the fourth circuit 1204 is implemented by the first wire lead; and both ends of the first wire lead are connected to the gate and the power voltage wire of the first transistor 1203, respectively. Being controlled by the fourth circuit, the first transistor 1203 is conducted during the “blowing” operation, and the first transistor 1203 provides a high impedance during the ESD event.

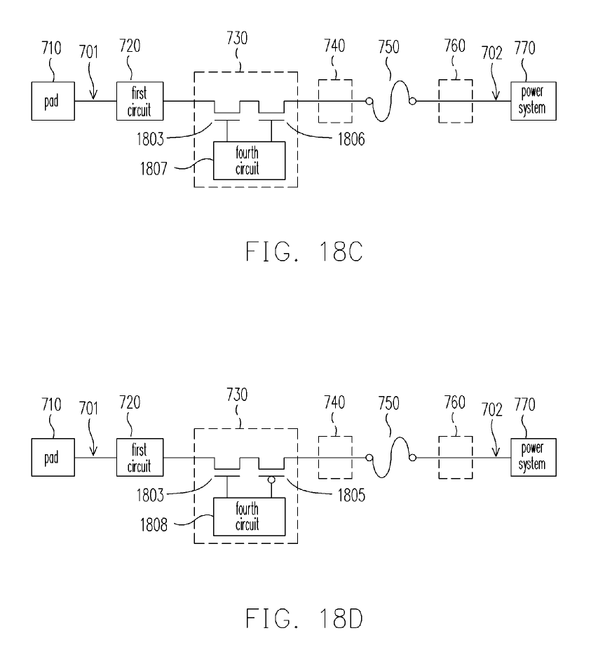

FIG. 13A illustrates another embodiment of the ESD protection apparatus 700 in FIG. 7 according to the present invention. Referring to FIG. 13A, the first circuit 720 and the second circuit 740 are implemented by wire leads; and the ESD protection unit 730 is implemented by the first transistor (here referred as the P-type transistor) 1301 and the fourth circuit 1302. And the programmable device 750 is implemented by the fuse. The first transistor 1301 is used as an ESD protection device with its gate connected to the fourth circuit 1302 and its source and drain connected to the pad 710 and the programmable device 750, respectively. In the present embodiment, a pull up/down circuit 780 is further coupled to the second end of the ESD protection unit 730. During the reading operation, the first transistor 1301 is cut off through the control of the fourth circuit 1302. Here, the pull up/down circuit 780 pulls the level of the second end of the ESD protection unit 730 up/down. Thus the programmable device 750 is avoided to float as the first transistor 1301 is cut off.

During the “blowing” operation, the external voltage is supplied to the programmable device 750 via the pad 710, and the first transistor 1301 is conducted through the control of the fourth circuit 1302. Meanwhile, the third circuit 760 is also conducted in preparation for the writing operation. Both the third circuit 760 and the first transistor 1301 provide low impedances, so that a current path is formed from the pad 710 to the power system 770. Heat is produced when the current is flowed through the programmable device 750. Therefore the programmable device 750 is programmed as expected by blowing the wire. The functions of the third circuit 760 can be achieved by any means for those skilled in the art, and therefore the embodiments implementing the third circuit 760 are not illustrated herein.

During the ESD event, the first transistor 1301 provides a high impedance to the current path from the pad 710 to power system 770. Since the first transistor 1301 is connected in the current path in series, the energy passed through the programmable device 750 resulting from the ESD event can be reduced, so that the energy is lower than the voltage required by the “blowing” operation of the programmable device 750. Therefore, the programmable device 750 can maintain its original state, and ensure the accuracy of the data stored therein.

The functions of the fourth circuit 1302 described above can be achieved by any means. For example, the fourth circuit 1302 is implemented by the first wire lead. And both ends of the first wire lead are connected to the gate and the ground voltage wire of the first transistor 1301, respectively. Furthermore, the implementation of the ESD protection unit 730 is not limited to the method described above. FIG. 13B illustrates another embodiment of the ESD protection apparatus 700 according to the present invention. FIG. 13B is similar to FIG. 13A, and the difference resides in the first transistor 1303 implementing the N-type transistor in the ESD protection unit 730 of FIG. 13B. The functions of the fourth circuit 1304 can be achieved by any means. For example, the fourth circuit 1304 is implemented by the first wire lead; and both ends of the first wire lead are connected to the gate and the power voltage wire of the first transistor 1303, respectively. Being controlled by the fourth circuit, the first transistor 1303 is conducted during the “blowing” operation, and the first transistor 1303 provides a high impedance during the ESD event.

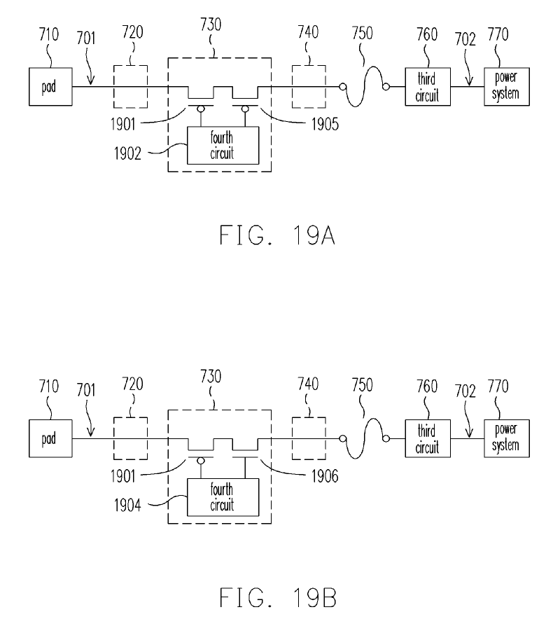

FIG. 14A illustrates another embodiment of the ESD protection apparatus 700 in FIG. 7 according to the present invention. Referring to FIG. 14A, the first circuit 720 and second circuit 740 are implemented by wire leads, and the ESD protection unit 730 is implemented by the first transistor (here referred as the P-type transistor) 1401 and the fourth circuit 1402; and the programmable device 750 is implemented by the fuse. The first transistor 1401 is used as an ESD protection device with its gate connected to the fourth circuit 1402 and its source and drain connected to the pad 710 and the programmable device 750, respectively. Generally, a conventional ESD protection device 711 is always disposed at the pad 710 in the design of the pad 710, in which the conventional ESD protection device 711 is coupled to the pad 710 (i.e. the first node 701). In the present embodiment, a pull up/down circuit 780 is further coupled at the second end of the ESD protection unit 730. During the reading operation, the first transistor 1401 is cut off through the control of the fourth circuit 1402. Here, the pull up/down circuit 780 pulls the level of second end of the ESD protection unit 730 up/down. Thus the programmable device 750 is avoided to float as the first transistor 1401 is cut off.

During the “blowing” operation, the external voltage is supplied to the programmable device 750 via the pad 710, and the first transistor 1401 is conducted through the control of the fourth circuit 1402. Meanwhile, the third circuit 760 is also conducted in preparation for the writing operation. Both the third circuit 760 and the first transistor 1401 provide low impedances, so that a current path is formed from the pad 710 to the power system 770. Heat is produced when the current flows through the programmable device 750, and therefore the programmable device 750 is programmed as expected by blowing the wire. The functions of the third circuit 760 can be achieved by any means for those skilled in the art, and therefore the embodiments implementing the third circuit 760 are not illustrated herein.

During the ESD event, the first transistor 1401 provides a high impedance to the current path from the pad 710 to power system 770. Since the first transistor 1401 is connected in the current path in series, the energy passed through the programmable device 750 resulting from the ESD event can be reduced, so that the energy is lower than the voltage required by the “blowing” operation of the programmable device 750. Furthermore, the electrostatic discharge can be dissipated via the conventional ESD protection device 711, so as to reduce the electrostatic discharge which is flowed through the programmable device 750. Therefore, the programmable device 750 can maintain its original state, and ensure the accuracy of the data stored therein.

The functions of the fourth circuit 1402 described above can be achieved by any means. For example, the fourth circuit 1402 is implemented by the first wire lead; and both ends of the first wire lead are connected to the gate and the ground voltage wire of the first transistor 1401, respectively. Furthermore, the implementation of the ESD protection unit 730 is not limited to the method described above. FIG. 14B illustrates another embodiment of the ESD protection apparatus 700 according to the present invention. FIG. 14B is similar to FIG. 14A, and the difference resides in the first transistor 1403 implementing the N-type transistor in the ESD protection unit 730 of FIG. 14B. The functions of fourth circuit 1404 can be achieved by any means. For example, the fourth circuit 1404 is implemented by the first wire lead; and both ends of the first wire lead are connected to the gate and the power voltage wire of the first transistor 1403, respectively. Being controlled by the fourth circuit 1404, the first transistor 1403 is conducted during the “blowing” operation, and the first transistor 1403 provides a high impedance during the ESD event.

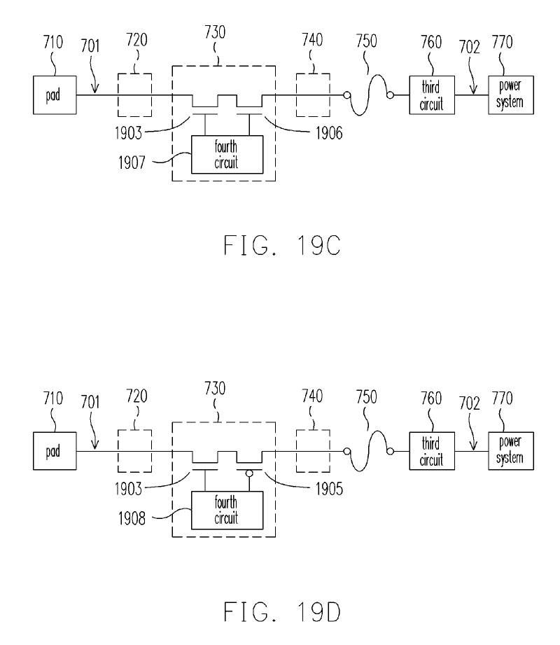

FIG. 15A illustrates another embodiment of the ESD protection apparatus 700 in FIG. 7 according to the present invention. Referring to FIG. 15A, the second circuit 740 is implemented by wire lead; and the ESD protection unit 730 is implemented by the first transistor (here referred as the P-type transistor) 1501 and the fourth circuit 1502; and the programmable device 750 is implemented by the fuse in the present embodiment. The programmable device 750 is programmed using the first circuit 720 and the third circuit 760 for determining whether the fuse should be blown. Alternatively, the state of the programmable device 750 is read by the first circuit 720 and the third circuit 760. The functions of the first circuit 720 and the third circuit 760 can be achieved by any means for those skilled in the art, and therefore there are no unnecessary details for the methods for carrying out the first circuit 720 and the third circuit 760. The first transistor 1501 is used as an ESD protection device with its gate connected to the fourth circuit 1502 and its source and drain connected to the first circuit 720 and the programmable device 750, respectively.

During the reading operation, the first transistor 1501 is cut off through the control of the fourth circuit 1502. Meanwhile, the third circuit 760 is also conducted in preparation for the reading operation. The voltage drop between both ends of the programmable device 750 is sensed by the first circuit 720. If the programmable device 750 is blown, the detected voltage is surely not equal to the level of the power system 770. If the programmable device 750 is not blown, the detected voltage is surely close to the level of the power system 770. And then, the first circuit 720 supplies the detected voltage to the secondary circuit (not shown), and the reading operation is completed.

During the “blowing” operation, the external voltage is supplied to the programmable device 750 via the pad 710, and the first transistor 1501 is conducted through the control of the fourth circuit 1502. Meanwhile, the first circuit 720 and the third circuit 760 are also conducted in preparation for the writing operation. The first circuit 720, the third circuit 760 and the first transistor 1501 provide low impedances, so that a current path is formed from the pad 710 to the power system 770. Heat is produced when the current flows through the programmable device 750, and therefore the programmable device 750 is programmed as expected by blowing the wire.

During the ESD event, the first transistor 1501 provides a high impedance to the current path from the pad 710 to power system 770. Since the first transistor 1501 is connected in the current path in series, the electrostatic voltage is divided by the supplied high impedance. Therefore, the energy passed through the programmable device 750 resulting from the ESD event can be reduced, so that the energy is lower than the voltage required by the “blowing” operation of the programmable device 750. Therefore, the programmable device 750 can maintain its original state, and ensure the accuracy of the data stored therein.

The functions of the fourth circuit 1502 described above can be achieved by any means. For example, the fourth circuit 1502 is implemented by the first wire lead; and both ends of the first wire lead are connected to the gate and the ground voltage wire of the first transistor 1501, respectively. Furthermore, the implementation of the ESD protection unit 730 is not limited to the method described above. FIG. 15B illustrates another embodiment of the ESD protection apparatus 700 according to the present invention. FIG. 15B is similar to FIG. 15A, and the difference resides in the first transistor 1503 implementing the N-type transistor in the ESD protection unit 730 of FIG. 15B. The functions of fourth circuit 1504 can be achieved by any means. For example, the fourth circuit 1504 is implemented by the first wire lead; and both ends of the first wire lead are connected to the gate and the power voltage wire of the first transistor 1503, respectively. Being controlled by the fourth circuit, the first transistor 1503 is conducted during the “blowing” operation, and the first transistor 1503 provides a high impedance during the ESD event.

FIG. 16A illustrates another embodiment of the ESD protection apparatus 700 in FIG. 7 according to the present invention. Referring to FIG. 16A, the second circuit 740 and the third circuit 760 are implemented by wire leads; and the ESD protection unit 730 is implemented by the first transistor (herein referred to as the P-type transistor) 1601 and the fourth circuit 1602; and the programmable device 750 is implemented by the fuse. The programmable device 750 is programmed using the first circuit 720 for determining whether the fuse should be blown. Alternatively, the state of the programmable device 750 is read by the first circuit 720. The functions of the first circuit 720 can be achieved by any means for those skilled in the art, and therefore the embodiments of the first circuit 720 is not illustrated herein. The first transistor 1601 is used as the ESD protection device with its gate connected the fourth circuit 1602 and its source and drain connected to the first circuit 720 and the programmable device 750, respectively.

During the reading operation, the first transistor 1601 is cut off through the control of the fourth circuit 1602. The voltage drop between both ends of the programmable device 750 is sensed by the first circuit 720. If the programmable device 750 is blown, the detected voltage is surely not equal to the level of the power system 770. If the programmable device 750 is not blown, the detected voltage is surely close to the level of the power system 770. And then, the first circuit 720 supplies the detected voltage to the secondary circuit (not shown), and the reading operation is completed. Additionally, if specially required, the first transistor 1601 can also be cut off through the control of the fourth circuit 1602, and thus the first circuit 720 can sense the information that the programmable device 750 (here the programmable device 750 is not blown) is blown and then output the information to the secondary circuit.

During the “blowing” operation, the external voltage is supplied to the programmable device 750 via the pad 710, and the first transistor 1601 is conducted through the control of the fourth circuit 1602. Meanwhile, the first circuit 720 is also conducted in preparation for the writing operation. Both the first circuit 720 and the first transistor 1601 provide low impedances, so that a current path is formed from the pad 710 to the power system 770. Heat is produced when the current flows through the programmable device 750, and therefore the programmable device 750 is programmed as expected by blowing the wire.

During the ESD event, the first transistor 1601 provides a high impedance to the current path from the pad 710 to power system 770. Since the first transistor 1601 is connected in the current path in series, the electrostatic voltage is divided by the supplied high impedance. Therefore, the energy passed through the programmable device 750 resulting from the ESD event can be reduced, so that the energy is lower than the voltage required by the “blowing” operation of the programmable device 750. Therefore, the programmable device 750 can maintain its original state, and ensure the accuracy of the data stored therein.

The functions of the fourth circuit 1602 described above can be achieved by any means. For example, the fourth circuit 1602 is implemented by the first wire lead; and both ends of the first wire lead are connected to the gate and the ground voltage wire of the first transistor 1601, respectively. Furthermore, the implementation of the ESD protection unit 730 is not limited to the method described above. FIG. 16B illustrates another embodiment of the ESD protection apparatus 700 according to the present invention. FIG. 16B is similar to FIG. 16A, and the difference resides in the first transistor 1603 implementing the N-type transistor in the ESD protection unit 730 of FIG. 16B. The functions of the fourth circuit 1604 can be achieved by any means. For example, the fourth circuit 1604 is implemented by the first wire lead; and both ends of the first wire lead are connected to the gate and the power voltage wire of the first transistor 1603, respectively. Being controlled by the fourth circuit, the first transistor 1603 is conducted during the “blowing” operation, and the first transistor 1603 provides a high impedance during the ESD event.

FIG. 17A illustrates another embodiment of the ESD protection apparatus 700 in FIG. 7 according to the present invention. Referring to FIG. 17A, the second circuit 740 is implemented by wire lead; and the ESD protection unit 730 is implemented by the first transistor 1701, second transistor 1705, and the fourth circuit 1702; and the programmable device 750 is implemented by the fuse, in which the first transistor 1701 and the second transistor 1705 are, for example, the P-type transistors. The programmable device 750 is programmed using the first circuit 720 and the third circuit 760 for determining whether the fuse should be blown. Alternatively, the state of the programmable device 750 is read by the first circuit 720 and the third circuit 760. The functions of the first circuit 720 and the third circuit 760 can be achieved by any means for those skilled in the art, and therefore there are no unnecessary details for the methods of carrying out the first circuit 720 and the third circuit 760. The first transistor 1701 and the second transistor 1705 are used as ESD protection devices with their gates connected to the fourth circuit 1702. The first transistor 1701 and the second transistor 1705 are connected in series between the first circuit 720 and the programmable device 750.

During the reading operation, the first transistor 1701 and the second transistor 1705 can be conducted through the control of the fourth circuit 1702. Meanwhile, the third circuit 760 is also conducted in preparation for the reading operation. The voltage drop between both ends of the programmable device 750 is sensed by the first circuit 720. If the programmable device 750 is blown, the detected voltage is surely not equal to the level of the power system 770. If the programmable device 750 is not blown, the detected voltage is surely close to the level of the power system 770. And then, the first circuit 720 supplies the detected voltage to the secondary circuit (not shown), and the reading operation is completed. Additionally, if specially required, the first transistor 1701 and the second transistor 1705 can also be cut off through the control of the fourth circuit 1702. And thus the first circuit 720 is able to sense the information that the programmable device 750 (here the programmable device 750 is not blown) is blown, and then the information is outputted to the secondary circuit.

During the “blowing” operation, the external voltage is supplied to the programmable device 750 via the pad 710, and the first transistor 1701 and the second transistor 1705 are conducted through the control of the fourth circuit 1702. Meanwhile, the first circuit 720 and the third circuit 760 are also conducted in preparation for the writing operation. The first circuit 720, the first transistor 1701, the second 1705 and the third circuit 760 provide low impedances, so that a current path is formed from the pad 710 to the power system 770. Heat is produced when the current flows through the programmable device 750, and therefore the programmable device 750 is programmed as expected by blowing the wire.

During the ESD event, the first transistor 1701 and the second transistor 1705 provide high impedances to the current path from the pad 710 to power system 770. Since the first transistor 1701 and the second transistor 1705 are connected in the current path in series, the electrostatic voltage is divided by the supplied high impedance. Therefore, the energy passed through the programmable device 750 resulting from the ESD event is reduced, so that the energy is lower than the voltage required by the “blowing” operation of the programmable device 750. Therefore, the programmable device 750 can maintain its original state, and ensure the accuracy of the data stored therein.

The functions of the fourth circuit 1702 described above can be achieved by any means. For example, the fourth circuit 1602 is implemented by the first wire lead and the second wire lead, in which both ends of the first wire lead are connected to the gate and the ground voltage wire of the first transistor 1701, respectively. And both ends of the second wire lead are connected to the gate and the ground voltage wire of the second transistor 1705, respectively.

Furthermore, the implementation of the ESD protection unit 730 is not limited to the method described above. FIG. 17B illustrates another embodiment of the ESD protection apparatus 700 according to the present invention. FIG. 17B is similar to FIG. 17A, and the difference resides in the second transistor 1706 implementing the N-type transistor in the ESD protection unit 730 of FIG. 17B. The functions of the fourth circuit 1704 can be achieved by any means. For example, the fourth circuit 1704 is implemented by the first wire lead and the second wire lead, in which both ends of the first wire lead are connected to the gate and the ground voltage wire of the first transistor 1701, respectively. And both ends of the second wire lead are connected to the gate and the power voltage wire of the second transistor 1706, respectively. Being controlled by the fourth circuit 1704, the first transistor 1701 and the second transistor 1706 are conducted during the “blowing” operation, and the first transistor 1701 and the second transistor 1706 provide high impedances during the ESD event.

FIG. 17C illustrates another embodiment of the ESD protection apparatus 700 according to the present invention. FIG. 17C is similar to FIG. 17A, and the difference resides in the first transistor 1703 and the second transistor 1706 implementing the N-type transistor in the ESD protection unit 730 of FIG. 17C. The functions of the fourth circuit 1707 can be achieved by any means. For example, the fourth circuit 1707 is implemented by the first wire lead and the second wire lead, in which both ends of the first wire lead are connected to the gate and the ground voltage wire of the first transistor 1703, respectively. And both ends of the second wire lead are connected to the gate and the power voltage wire of the second transistor 1706, respectively. Being controlled by the fourth circuit 1707, the first transistor 1703 and the second transistor 1706 are conducted during the “blowing” operation, and the first transistor 1703 and the second transistor 1706 provide high impedances during the ESD event.

FIG. 17D illustrates another embodiment of the ESD protection apparatus 700 according to the present invention. FIG. 17D is similar to FIG. 17A, and the difference resides in the first transistor 1703 implementing the N-type transistor in the ESD protection unit 730 of FIG. 17D. The functions of the fourth circuit 1708 can be achieved by any means. For example, the fourth circuit 1708 is implemented by the first wire lead and the second wire lead, in which both ends of the first wire lead are connected to the gate and the power voltage wire of the first transistor 1703, respectively. And both ends of the second wire lead are connected to the gate and the ground voltage wire of the second transistor 1705 respectively. Being controlled by the fourth circuit 1708, the first transistor 1703 and the second transistor 1705 are conducted during the “blowing” operation, and the first transistor 1703 and the second transistor 1705 provide high impedances during the ESD event.

FIG. 18A illustrates another embodiment of the ESD protection apparatus 700 according to the present invention. FIG. 18A is similar to FIG. 16A, and the difference resides in the ESD protection unit 730 implementing the fourth circuit 1802, the P-type transistors 1801 and 1805 in FIG. 18A. Being controlled by the fourth circuit 1802, the first transistor 1801 and the second transistor 1805 are conducted during the “blowing” operation, and the first transistor 1801 and the second transistor 1805 provide high impedances during the ESD event. The functions of the fourth circuit 1802 can be achieved by any means. For example, the fourth circuit 1802 is implemented by the first wire lead and the second wire lead, in which both ends of the first wire lead are connected to the gate and the ground voltage wire of the first transistor 1801, respectively. And both ends of the second wire lead are connected to the gate and the ground voltage wire of the second transistor 1805, respectively.

FIG. 18B illustrates another embodiment of the ESD protection apparatus 700 according to the present invention. FIG. 18B is similar to FIG. 18A, and the difference resides in the second transistor 1806 implementing the N-type transistor in the ESD protection unit 730 of FIG. 18B. Being controlled by the fourth circuit 1804, the first transistor 1801 and the second transistor 1806 are conducted during the “blowing” operation, and the first transistor 1801 and the second transistor 1806 provide high impedances during the ESD event. The functions of the fourth circuit 1804 can be achieved by any means. For example, the fourth circuit 1804 is implemented by the first wire lead and the second wire lead, in which both ends of the first wire lead are connected to the gate and the ground voltage wire of the first transistor 1801, respectively. And both ends of the second wire lead are connected to the gate and the power voltage wire of the second transistor 1806, respectively.

FIG. 18C illustrates another embodiment of the ESD protection apparatus 700 according to the present invention. FIG. 18C is similar to FIG. 18A, and the difference resides in the first transistor 1803 and the second transistor 1806 implementing the N-type transistor in the ESD protection unit 730 of FIG. 18C. Being controlled by the fourth circuit 1807, the first transistor 1803 and the second transistor 1806 are conducted during the “blowing” operation, and the first transistor 1803 and the second transistor 1806 provide high impedances during the ESD event. The functions of the fourth circuit 1807 can be achieved by any means. For example, the fourth circuit 1807 is implemented by the first wire lead and the second wire lead, in which both ends of the first wire lead are connected to the gate and the power voltage wire of the first transistor 1803, respectively. And both ends of the second wire lead are connected to the gate and the power voltage wire of the second transistor 1806, respectively.

FIG. 18D illustrates another embodiment of the ESD protection apparatus 700 according to the present invention. FIG. 18D is similar to FIG. 18A, and the difference resides in the first transistor 1803 implementing the N-type transistor in the ESD protection unit 730 of FIG. 18D. Being controlled by the fourth circuit 1808, the first transistor 1803 and the second transistor 1805 are conducted during the “blowing” operation, and the first transistor 1803 and the second transistor 1805 provide high impedances during the ESD event. The functions of the fourth circuit 1808 can be achieved by any means. For example, the fourth circuit 1808 is implemented by the first wire lead and the second wire lead, in which both ends of the first wire lead are connected to the gate and the power voltage wire of the first transistor 1803, respectively. And both ends of the second wire lead are connected to the gate and the ground voltage wire of the second transistor 1805, respectively.

FIG. 19A illustrates another embodiment of the ESD protection apparatus 700 according to the present invention. FIG. 19A is similar to FIG. 11A, and the difference resides in the ESD protection unit 730 implementing the fourth circuit 1902, the P-type transistors 1901 and 1905 in FIG. 19A. Being controlled by the fourth circuit 1902, the first transistor 1901 and the second transistor 1905 are conducted during the “blowing” operation, and the first transistor 1901 and the second transistor 1905 provide high impedances during the ESD event. The functions of the fourth circuit 1902 can be achieved by any means. For example, the fourth circuit 1902 is implemented by the first wire lead and the second wire lead, in which both ends of the first wire lead are connected to the gate and the ground voltage wire of the first transistor 1901, respectively. And both ends of the second wire lead are connected to the gate and the ground voltage wire of the second transistor 1905, respectively.

FIG. 19B illustrates another embodiment of the ESD protection apparatus 700 according to the present invention. FIG. 19B is similar to FIG. 19A, and the difference resides in the second transistor 1906 implementing the N-type transistor in the ESD protection unit 730 of FIG. 19B. Being controlled by the fourth circuit 1904, the first transistor 1901 and the second transistor 1906 are conducted during the “blowing” operation, and the first transistor 1901 and the second transistor 1906 provide high impedances during the ESD event. The functions of the fourth circuit 1904 can be achieved by any means. For example, the fourth circuit 1904 is implemented by the first wire lead and the second wire lead, in which both ends of the first wire lead are connected to the gate and the ground voltage wire of the first transistor 1901, respectively. And both ends of the second wire lead are connected to the gate and the power voltage wire of the second transistor 1906, respectively.

FIG. 19C illustrates another embodiment of the ESD protection apparatus 700 according to the present invention. FIG. 19C is similar to FIG. 19A, and the difference resides in the first transistor 1903 and the second transistor 1906 implementing the N-type transistor in the ESD protection unit 730 of FIG. 19C. Being controlled by the fourth circuit 1907, the first transistor 1903 and the second transistor 1906 are conducted during the “blowing” operation, and the first transistor 1903 and the second transistor 1906 provide high impedances during the ESD event. The functions of the fourth circuit 1907 can be achieved by any means. For example, the fourth circuit 1907 is implemented by the first wire lead and the second wire lead, in which both ends of the first wire lead are connected to the gate and the power voltage wire of the first transistor 1903, respectively. And both ends of the second wire lead are connected to the gate and the power voltage wire of the second transistor 1906, respectively.

FIG. 19D illustrates another embodiment of the ESD protection apparatus 700 according to the present invention. FIG. 19D is similar to FIG. 19A, and the difference resides in the first transistor 1903 implementing the N-type transistor in the ESD protection unit 730 of FIG. 19D. Being controlled by the fourth circuit 1908, the first transistor 1903 and the second transistor 1905 are conducted during the “blowing” operation, and the first transistor 1903 and the second transistor 1905 provide high impedances during the ESD event. The functions of the fourth circuit 1908 can be achieved by any means. For example, the fourth circuit 1908 is implemented by the first wire lead and the second wire lead, in which both ends of the first wire lead are connected to the gate and the power voltage wire of the first transistor 1903, respectively. And both ends of the second wire lead are connected to the gate and the ground voltage wire of the second transistor 1905, respectively.

FIG. 8 is a block diagram of the ESD protection apparatus for the programmable device according to the embodiment of the present invention. Referring to FIG. 8, the ESD protection apparatus 800 includes a fifth circuit 820, programmable device 830, an ESD protection unit 840, and a sixth circuit 850. The first and second ends of the fifth circuit 820 are electrically connected to a first node 801 and the first end of the programmable device 830, respectively. The programmable device is used for recording the programming results. The first end of the ESD protection unit 840 is electrically connected to the second end of the programmable device 830. The first and second ends of the sixth circuit 850 are electrically connected to the second end of the ESD protection unit 840 and a second node 802, respectively. The programmable device 830 can be programmed by the fifth circuit 820 and the sixth circuit 850, and/or the programming results of the programmable device 830 is obtained by the fifth circuit 820 and the sixth circuit 850. In the present embodiment, the first node 801 and the second node 802 are electrically connected to a pad 810 and a power system 860, respectively. The power system 860 is decided to be a power voltage wire, a ground voltage wire or else as required by the designer.

Generally, a conventional ESD protection device 811 is always disposed at the pad 810 in the design of the pad 810, in which the conventional ESD protection device 811 is coupled to the pad 810 (i.e. the first node 810). When the ESD has occurred, a high impedance is provided by the ESD protection unit 840 to reduce the voltage drop between both ends of the programmable device 830, so that the programmable device 830 is protected from the damage deduced by the ESD event. Of course, the electrostatic discharge can be dissipated via the conventional ESD protection device 811, so as to reduce the electrostatic discharge which is flowed through the programmable device 830.

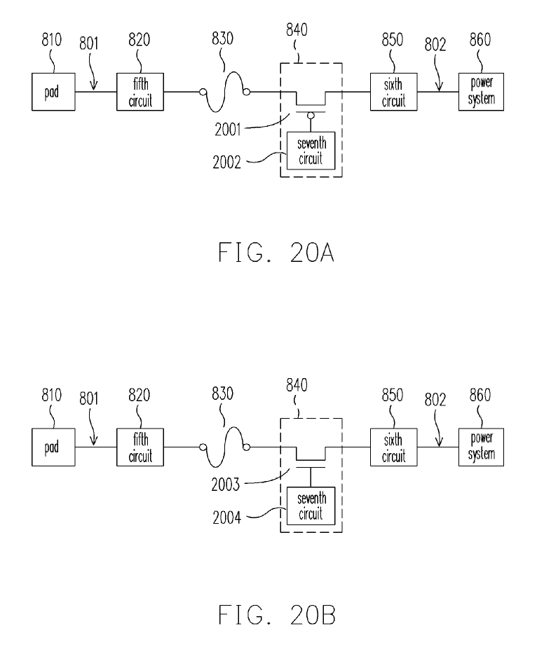

FIGS. 20A-25D respectively illustrate a plurality of embodiments of the ESD protection apparatus 800 in FIG. 8 according to the present invention. Referring to FIG. 20A, in the present embodiment, the ESD protection unit 840 is implemented by the first transistor (herein referred to as a P-type transistor) 2001 and the seventh circuit 2002; and the programmable device 830 is implemented by the fuse. The programmable device 830 is programmed by the fifth circuit 820 and the sixth circuit 850, i.e. to determine whether the fuse should be blown. Alternatively, the state of the programmable device 830 is read by the fifth circuit 820 and the sixth circuit 850. The functions of the fifth circuit 820 and the sixth circuit 850 can be achieved by any means for those skilled in the art, and therefore there are no unnecessary details for the methods of carrying out the fifth circuit 820 and the sixth circuit 850. The first transistor 2001 is used as an ESD protection device with its gate connected to the seventh circuit 2002 and its source and drain connected to the programmable device 830 and the sixth circuit 850, respectively.

During the reading operation, the first transistor 2001 can be conducted through the control of the seventh circuit 2002. Meanwhile, the sixth circuit 850 is also conducted in preparation for the reading operation. The voltage drop between both ends of the programmable device 830 is sensed by the fifth circuit 820. If the programmable device 830 is blown, the detected voltage is surely not close to the level of the power system 860 (such as the ground voltage). If the programmable device 830 is not blown, the detected voltage is surely close to the level of the power system 860. And then, the fifth circuit 820 supplies the detected voltage to the secondary circuit (not shown), and the reading operation is completed. Additionally, if specially required, the first transistor 2001 can also be cut off through the control of the seventh circuit 2002, and thus the fifth circuit 820 can sense the information that the programmable device 830 (although the programmable device 830 is not blown actually) is blown and then output the information to the secondary circuit.

During the “blowing” operation, the external voltage is supplied to the programmable device 830 via the pad 810, and the first transistor 2001 is conducted through the control of the seventh circuit 2002. Meanwhile, the fifth circuit 820 and the sixth circuit 850 are also conducted in preparation for the writing operation. The fifth circuit 820, the sixth circuit 850 and the first transistor 2001 provide low impedances, so that a current path is formed from the pad 810 to the power system 860. Heat is produced when the current flows through the programmable device 830, and therefore the programmable device 830 is programmed as expected by blowing the wire.

During the ESD event, the first transistor 2001 provides a high impedance to the current path from the pad 810 to the power system 860. Since the first transistor 2001 is connected in the current path in series, the electrostatic voltage is divided by the supplied high impedance. Therefore, the energy passed through the programmable device 830 resulting from the ESD event is reduced, so that the energy is lower than the voltage required by the “blowing” operation of the programmable device 830. Therefore, the programmable device 830 can maintain its original state, and ensure the accuracy of the data stored therein.

The functions of the seventh circuit 2002 described above can be achieved by any means. For example, the seventh circuit 2002 is implemented by the first wire lead; and both ends of the first wire lead are connected to the gate and the ground voltage wire of the first transistor 2001, respectively. Furthermore, the implementation of the ESD protection unit 840 is not limited to the method described above. FIG. 20B illustrates another embodiment of the ESD protection apparatus 800 according to the present invention. FIG. 20B is similar to FIG. 20A, and the difference resides in the first transistor 2003 implementing the N-type transistor in the ESD protection unit 840 of FIG. 20B. Being controlled by the seventh circuit 2004, the first transistor 2003 is conducted during the “blowing” operation, and the first transistor 2003 provides a high impedance during the ESD event. The functions of the seventh circuit 2004 can be achieved by any means. For example, the seventh circuit 2004 is implemented by the first wire lead; and both ends of the first wire lead are connected to the gate and the power voltage wire of the first transistor 2003, respectively.

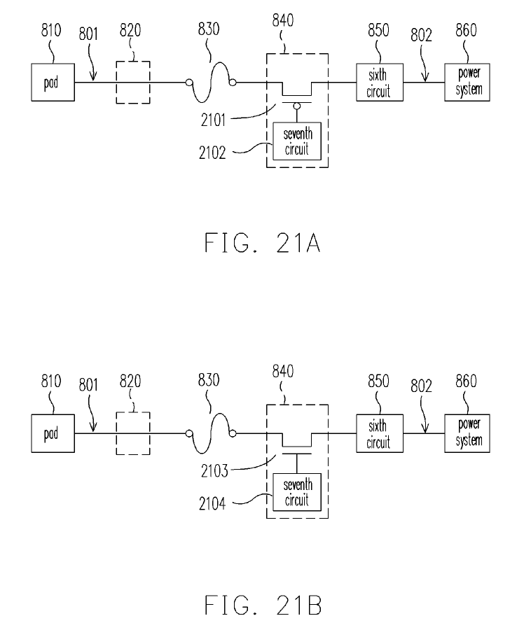

FIG. 21A illustrates an embodiment of the ESD protection apparatus 800 in FIG. 8 according to the present invention. Referring to FIG. 21A, the fifth circuit 820 is implemented by wire lead; and the ESD protection unit 840 is implemented by the first transistor (herein referred to as a P-type transistor) 2101 and the seventh circuit 2102; and the programmable device 830 is implemented by the fuse. The programmable device 830 is programmed by the sixth circuit 850, i.e. to determine whether the fuse should be blown. The functions of the sixth circuit 850 can be achieved by any means for those skilled in the art, and therefore there are no unnecessary details for the methods of carrying out the fifth circuit 820 and the sixth circuit 850. The first transistor 2101 is used as an ESD protection device with its gate connected to the seventh circuit 2102 and its source and drain connected to the programmable device 830 and the sixth circuit 850, respectively.

During the reading operation, the first transistor 2101 can be conducted through the control of the seventh circuit 2102. Meanwhile, the sixth circuit 850 is also conducted, so as to facilitate the reading operation of the sensing circuit (not shown). Additionally, if specially required, the first transistor 2101 can also be cut off through the control of the seventh circuit 2102, and thus the sensing circuit 720 (not shown) can sense the information that the programmable device 830 (although the programmable device 830 is not blown actually) is blown and then output the information to the secondary circuit.

During the “blowing” operation, the external voltage is supplied to the programmable device 830 via the pad 810, and the first transistor 2101 is conducted through the control of the seventh circuit 2102. Meanwhile, the sixth circuit 850 is also conducted in preparation for the writing operation. Both the sixth circuit 850 and the first transistor 2101 provide low impedances, so that a current path is formed from the pad 810 to the power system 860. Heat is produced when the current flows through the programmable device 830, and therefore the programmable device 830 is programmed as expected by blowing the wire.

During the ESD event, the first transistor 2101 provides a high impedance to the current path from the pad 810 to the power system 860. Since the first transistor 2101 is connected in the current path in series, the electrostatic voltage is divided by the supplied high impedance. Therefore, the energy passed through the programmable device 830 resulting from the ESD event is reduced, so that the energy is lower than the voltage required by the “blowing” operation of the programmable device 830. Therefore, the programmable device 830 can maintain its original state, and ensure the accuracy of the data stored therein.

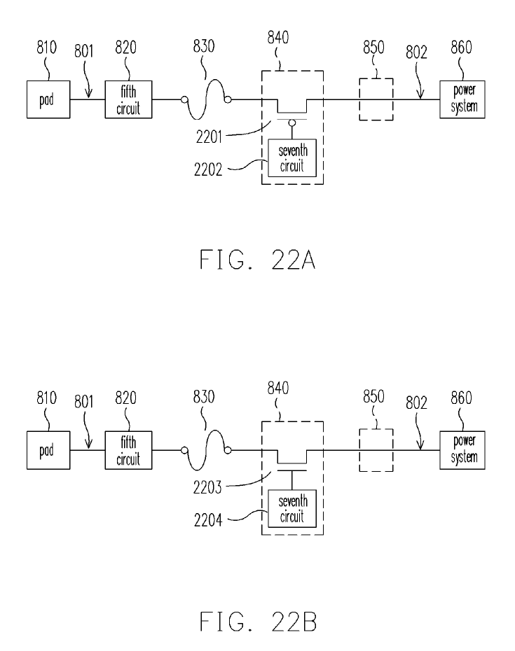

The functions of the seventh circuit 2102 described above can be achieved by any means. For example, the seventh circuit 2102 is implemented by the first wire lead; and both ends of the first wire lead are connected to the gate and the ground voltage wire of the first transistor 2101, respectively. Furthermore, the implementation of the ESD protection unit 840 is not limited to the method described above. FIG. 22B illustrates another embodiment of the ESD protection apparatus 800 according to the present invention. FIG. 22B is similar to FIG. 22A, and the difference resides in the first transistor 2103 implementing the N-type transistor in the ESD protection unit 840 of FIG. 21B. Being controlled by the seventh circuit 2104, the first transistor 2103 is conducted during the “blowing” operation, and the first transistor 2103 provides a high impedance during the ESD event. The functions of the seventh circuit 2104 can be achieved by any means. For example, the seventh circuit 2104 is implemented by the first wire lead; and both ends of the first wire lead are connected to the gate and the power voltage wire of the first transistor 2103, respectively.

FIG. 22A illustrates an embodiment of the ESD protection apparatus 800 in FIG. 8 according to the present invention. Referring to FIG. 22A, the sixth circuit 850 is implemented by wire lead; and the ESD protection unit 840 is implemented by the first transistor (herein referred to as a P-type transistor) 2201, and the seventh circuit 2202; and the programmable device 830 is implemented by the fuse. The programmable device 830 is programmed by the fifth circuit 820, i.e. to determine whether the fuse should be blown. Alternatively, the state of the programmable device 830 is read by the fifth circuit 820. The functions of the fifth circuit 820 can be achieved by any means for those skilled in the art, and therefore the embodiments implementing the fifth circuit 820 are not illustrated herein. The first transistor 2201 is used as an ESD protection device with its gate connected to the seventh circuit 2202 and its source and drain connected to the programmable device 830 and the power system 860, respectively.

During the reading operation, the first transistor 2201 can be conducted through the control of the seventh circuit 2202. The voltage drop between both ends of the programmable device 830 is sensed by the fifth circuit 820. If the programmable device 830 is blown, the detected voltage is surely not equal to the level of the power system 860 (such as the ground voltage). If the programmable device 830 is not blown, the detected voltage is surely close to the level of the power system 860. And then, the fifth circuit 820 supplies the detected voltage to the secondary circuit (not shown), and the reading operation is completed. Additionally, if specially required, the first transistor 2201 can also be cut off through the control of the seventh circuit 2202, and thus the fifth circuit 820 can sense the information that the programmable device 830 (although the programmable device 830 is not blown actually) is blown and then output the information to the secondary circuit.

During the “blowing” operation, the external voltage is supplied to the programmable device 830 via the pad 810, and the first transistor 2201 is conducted through the control of the seventh circuit 2202. Meanwhile, the fifth circuit 820 is also conducted in preparation for the writing operation. Both the fifth circuit 820 and the first transistor 2201 provide low impedances, so that a current path is formed from the pad 810 to the power system 860. Heat is produced when the current flows through the programmable device 830, and therefore the programmable device 830 is programmed as expected by blowing the wire.

During the ESD event, the first transistor 2201 provides a high impedance to the current path from the pad 810 to the power system 860. Since the first transistor 2201 is connected in the current path in series, the electrostatic voltage is divided by the supplied high impedance. Therefore, the energy passed through the programmable device 830 resulting from the ESD event is reduced, so that the energy is lower than the voltage required by the “blowing” operation of the programmable device 830. The programmable device 830 can maintain its original state, and ensure the accuracy of the data stored therein.

The functions of the seventh circuit 2202 described above can be achieved by any means. For example, the seventh circuit 2202 is implemented by the first wire lead; and both ends of the first wire lead are connected to the gate and the ground voltage wire of the first transistor 2201, respectively. Furthermore, the implementation of the ESD protection unit 840 is not limited to the method described above. FIG. 22B illustrates another embodiment of the ESD protection apparatus 800 according to the present invention. FIG. 22B is similar to FIG. 22A, and the difference resides in the first transistor 2203 implementing the N-type transistor in the ESD protection unit 840 of FIG. 22B. Being controlled by the seventh circuit 2204, the first transistor 2203 is conducted during the “blowing” operation, and the first transistor 2203 provides a high impedance during the ESD event. The functions of the seventh circuit 2204 can be achieved by any means. For example, the seventh circuit 2204 is implemented by the first wire lead; and both ends of the first wire lead are connected to the gate and the power voltage wire of the first transistor 2203, respectively.

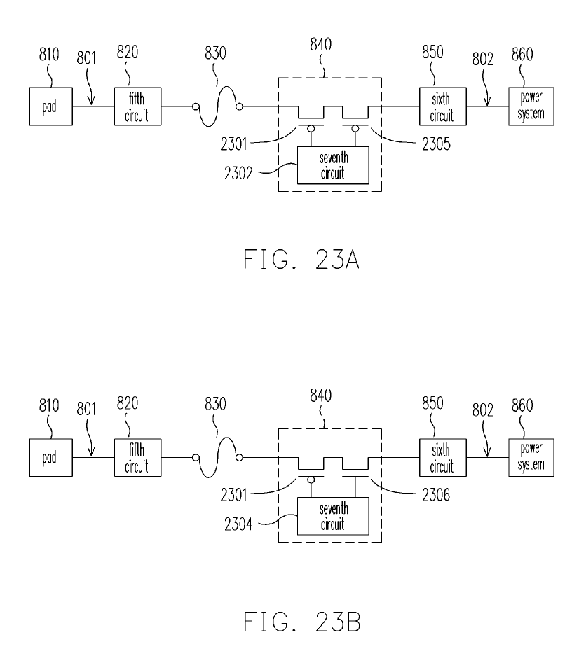

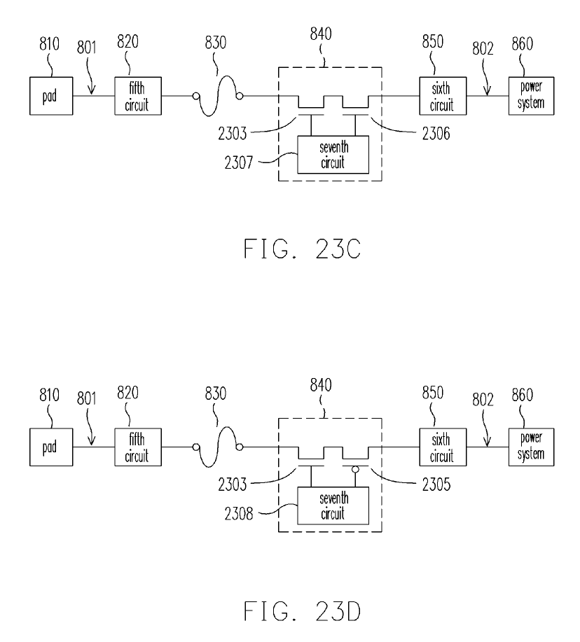

FIG. 23A illustrates another embodiment of the ESD protection apparatus 800 according to the present invention. FIG. 23A is similar to FIG. 20A, and the difference resides in the ESD protection unit 840 implementing the seventh circuit 2302, the P-type transistors 2301 and 2305 in FIG. 23A. Being controlled by the seventh circuit 2302, the first transistor 2301 and the second transistor 2305 are conducted during the “blowing” operation, and the first transistor 2301 and the second transistor 2305 provide high impedances during the ESD event. The functions of the seventh circuit 2302 can be achieved by any means. For example, the seventh circuit 2302 is implemented by the first wire lead and the second wire lead, in which both ends of the first wire lead are connected to the gate and the ground voltage wire of the first transistor 2301, respectively. And both ends of the second wire lead are connected to the gate and the ground voltage wire of the second transistor 2305, respectively.

FIG. 23B illustrates another embodiment of the ESD protection apparatus 800 according to the present invention. FIG. 23B is similar to FIG. 23A, and the difference resides the second ESD protection unit 2306 implementing the N-type transistor in the ESD protection unit 840 of FIG. 23B. Being controlled by the seventh circuit 2304, the first transistor 2301 and the second transistor 2306 are conducted during the “blowing” operation, and the first transistor 2301 and the second transistor 2306 provide high impedances during the ESD event. The functions of the seventh circuit 2304 can be achieved by any means. For example, the seventh circuit 2304 is implemented by the first wire lead and the second wire lead, in which both ends of the first wire lead are connected to the gate and the ground voltage wire of the first transistor 2301, respectively. And both ends of the second wire lead are connected to the gate and the power voltage wire of the second transistor 2306, respectively.

FIG. 23C illustrates another embodiment of the ESD protection apparatus 800 according to the present invention. FIG. 23C is similar to FIG. 23A, and the difference resides in the first transistor 2303 and the second transistor 2306 implementing the N-type transistor in the ESD protection unit 840 of FIG. 23C. Being controlled by the seventh circuit 2307, the first transistor 2303 and the second transistor 2306 are conducted during the “blowing” operation, and the first transistor 2303 and the second transistor 2306 provide high impedances during the ESD event. The functions of the seventh circuit 2307 can be achieved by any means. For example, the seventh circuit 2307 is implemented by the first wire lead and the second wire lead, in which both ends of the first wire lead are connected to the gate and the power voltage wire of the first transistor 2303, respectively. And both ends of the second wire lead are connected to the gate and the power voltage wire of the second transistor 2306, respectively.

FIG. 23D illustrates another embodiment of the ESD protection apparatus 800 according to the present invention. FIG. 23D is similar to FIG. 23A, and the difference resides in the first transistor 2303 implementing the N-type transistor in the ESD protection unit 840 of FIG. 23D. Being controlled by the seventh circuit 2308, the first transistor 2303 and the second transistor 2305 are conducted during the “blowing” operation, and the first transistor 2303 and the second transistor 2305 provide high impedances during the ESD event. The functions of the seventh circuit 2308 can be achieved by any means. For example, the seventh circuit 2308 is implemented by the first wire lead and the second wire lead, in which both ends of the first wire lead are connected to the gate and the power voltage wire of the first transistor 2303, respectively. And both ends of the second wire lead are connected to the gate and the ground voltage wire of the second transistor 2305, respectively.

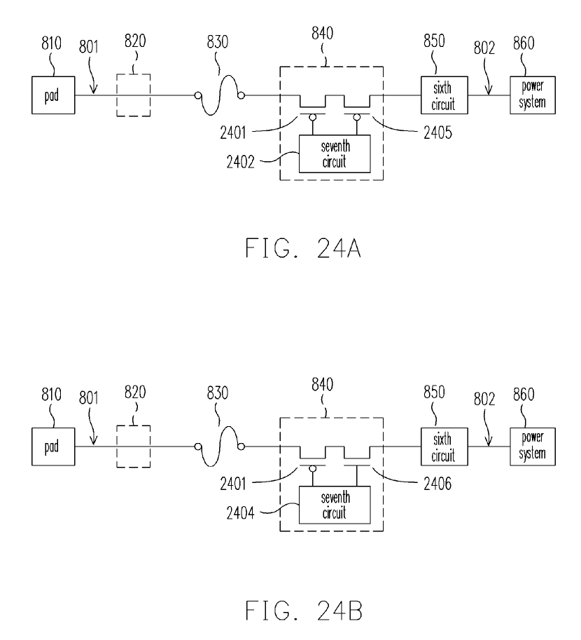

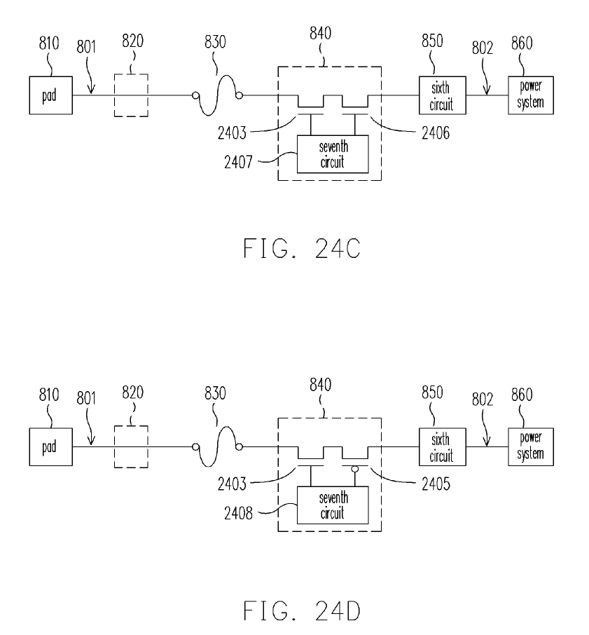

FIG. 24A illustrates another embodiment of the ESD protection apparatus 800 according to the present invention. FIG. 24A is similar to FIG. 21A, the difference resides in the ESD protection unit 840 implementing the seventh circuit 2402 and the P-type transistors 2401 and 2405 in FIG. 24A. Being controlled by the seventh circuit 2402, the first transistor 2401 and the second transistor 2405 are conducted during the “blowing” operation, and the first transistor 2401 and the second transistor 2405 provide high impedances during the ESD event. The functions of the seventh circuit 2402 can be achieved by any means. For example, the seventh circuit 2402 is implemented by the first wire lead and the second wire lead, in which both ends of the first wire lead are connected to the gate and the ground voltage wire of the first transistor 2401, respectively. And both ends of the second wire lead are connected to the gate and the ground voltage wire of the second transistor 2405, respectively.

FIG. 24B illustrates another embodiment of the ESD protection apparatus 800 according to the present invention. FIG. 24B is similar to FIG. 24A, and the difference resides in the second transistor 2406 implementing the N-type transistor in the ESD protection unit 840 of FIG. 24B. Being controlled by the seventh circuit 2404, the first transistor 2401 and the second transistor 2406 are conducted during the “blowing” operation, and the first transistor 2401 and the second transistor 2406 provide high impedances during the ESD event. The functions of the seventh circuit 2404 can be achieved by any means. For example, the seventh circuit 2404 is implemented by the first wire lead and the second wire lead, in which both ends of the first wire lead are connected to the gate and the ground voltage wire of the first transistor 2401, respectively. And both ends of the second wire lead are connected to the gate and the power voltage wire of the second transistor 2406, respectively.

FIG. 24C illustrates another embodiment of the ESD protection apparatus 800 according to the present invention. FIG. 24C is similar to FIG. 24A, and the difference resides in the first transistor 2403 and the second transistor 2406 implementing the N-type transistor in the ESD protection unit 840 of FIG. 24C. Being controlled by the seventh circuit 2407, the first transistor 2403 and the second transistor 2406 are conducted during the “blowing” operation, and the first transistor 2403 and the second transistor 2406 provide high impedances during the ESD event. The functions of the seventh circuit 2407 can be achieved by any means. For example, the seventh circuit 2407 is implemented by the first wire lead and the second wire lead, in which both ends of the first wire lead are connected to the gate and the power voltage wire of the first transistor 2403, respectively. And both ends of the second wire lead are connected to the gate and the power voltage wire of the second transistor 2406, respectively.

FIG. 24D illustrates another embodiment of the ESD protection apparatus 800 according to the present invention. FIG. 24D is similar to FIG. 24A, and the difference resides in the first transistor 2403 implementing the N-type transistor in the ESD protection unit 840 of FIG. 24D. Being controlled by the seventh circuit 2408, the first transistor 2403 and the second transistor 2405 are conducted during the “blowing” operation, and the first transistor 2403 and the second transistor 2405 provide high impedances during the ESD event. The functions of the seventh circuit 2408 can be achieved by any means. For example, the seventh circuit 2408 is implemented by the first wire lead and the second wire lead, in which both ends of the first wire lead are connected to the gate and the power voltage wire of the first transistor 2403, respectively. And both ends of the second wire lead are connected to the gate and the ground voltage wire of the second transistor 2405, respectively.

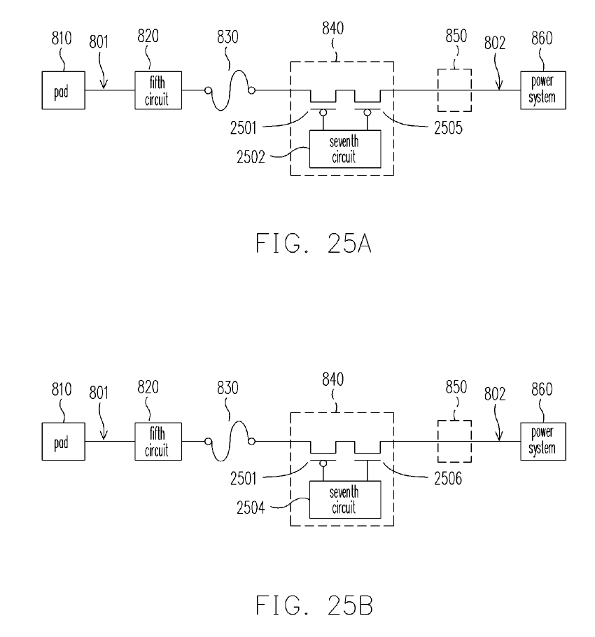

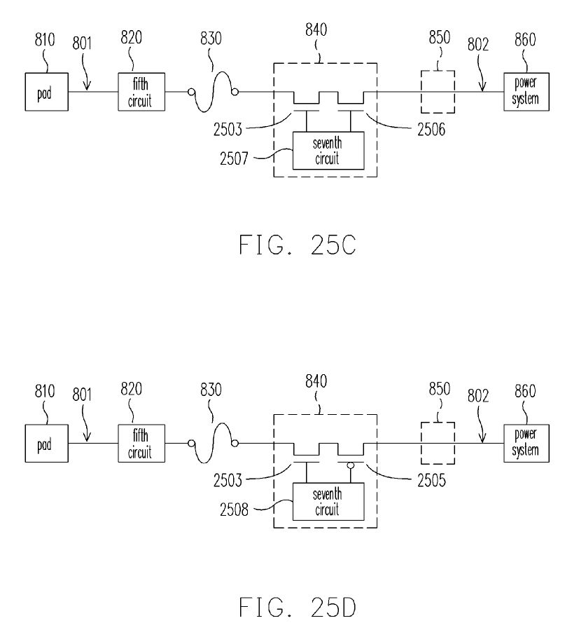

FIG. 25A illustrates another embodiment of the ESD protection apparatus 800 according to the present invention. FIG. 25A is similar to FIG. 22A, and the difference resides in the ESD protection unit 840 implementing the seventh circuit 2502 and the P-type transistors 2501 and 2505 in FIG. 25A. Being controlled by the seventh circuit 2502, the first transistor 2501 and the second transistor 2505 are conducted during the “blowing” operation, and the first transistor 2501 and the second transistor 2505 provide high impedances during the ESD event. The functions of the seventh circuit 2502 can be achieved by any means. For example, the seventh circuit 2502 is implemented by the first wire lead and the second wire lead, in which both ends of the first wire lead are connected to the gate and the ground voltage wire of the first transistor 2501, respectively. And both ends of the second wire lead are connected to the gate and the ground voltage wire of the second transistor 2505, respectively.

FIG. 25B illustrates another embodiment of the ESD protection apparatus 800 according to the present invention. FIG. 25B is similar to FIG. 25A, and the difference resides in the second transistor 2506 implementing the N-type transistor in the ESD protection unit 840 of FIG. 25B. Being controlled by the seventh circuit 2504, the first transistor 2501 and the second transistor 2506 are conducted during the “blowing” operation, and the first transistor 2501 and the second transistor 2506 provide high impedances during the ESD event. The functions of the seventh circuit 2504 can be achieved by any means. For example, the seventh circuit 2504 is implemented by the first wire lead and the second wire lead, in which both ends of the first wire lead are connected to the gate and the ground voltage wire of the first transistor 2501, respectively. And both ends of the second wire lead are connected to the gate and the power voltage wire of the second transistor 2506, respectively.

FIG. 25C illustrates another embodiment of the ESD protection apparatus 800 according to the present invention. FIG. 25C is similar to FIG. 25A, and the difference resides in the first transistor 2503 and the second transistor 2506 implementing the N-type transistor in the ESD protection unit 840 of FIG. 25C. Being controlled by the seventh circuit 2507, the first transistor 2503 and the second transistor 2506 are conducted during the “blowing” operation, and the first transistor 2503 and the second transistor 2506 provide high impedances during the ESD event. The functions of the seventh circuit 2507 can be achieved by any means. For example, the seventh circuit 2507 is implemented by the first wire lead and the second wire lead, in which both ends of the first wire lead are connected to the gate and the power voltage wire of the first transistor 2503, respectively. And both ends of the second wire lead are connected to the gate and the power voltage wire of the second transistor 2506, respectively.

FIG. 25D illustrates another embodiment of the ESD protection apparatus 800 according to the present invention. FIG. 25D is similar to FIG. 25A, and the difference resides in the first transistor 2503 implementing the N-type transistor in the ESD protection unit 840 of FIG. 25D. Being controlled by the seventh circuit 2508, the first transistor 2503 and the second transistor 2505 are conducted during the “blowing” operation, and the first transistor 2503 and the second transistor 2505 provide high impedances during the ESD event. The functions of the seventh circuit 2508 can be achieved by any means. For example, the seventh circuit 2508 is implemented by the first wire lead and the second wire lead, in which both ends of the first wire lead are connected to the gate and the power voltage wire of the first transistor 2503, respectively. And both ends of the second wire lead are connected to the gate and the ground voltage wire of the second transistor 2505, respectively.

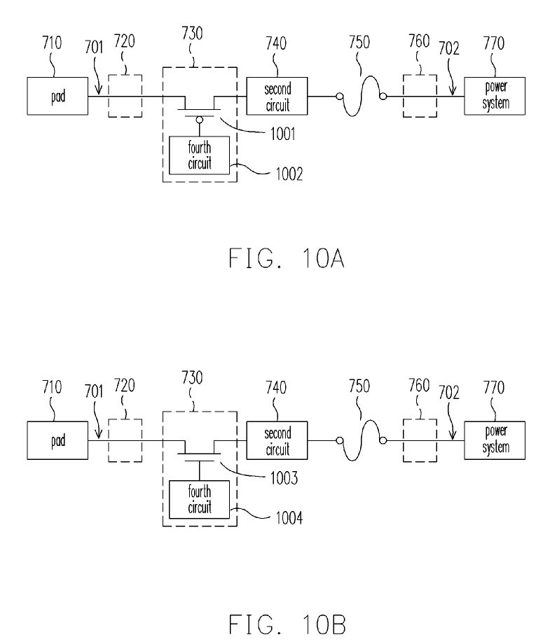

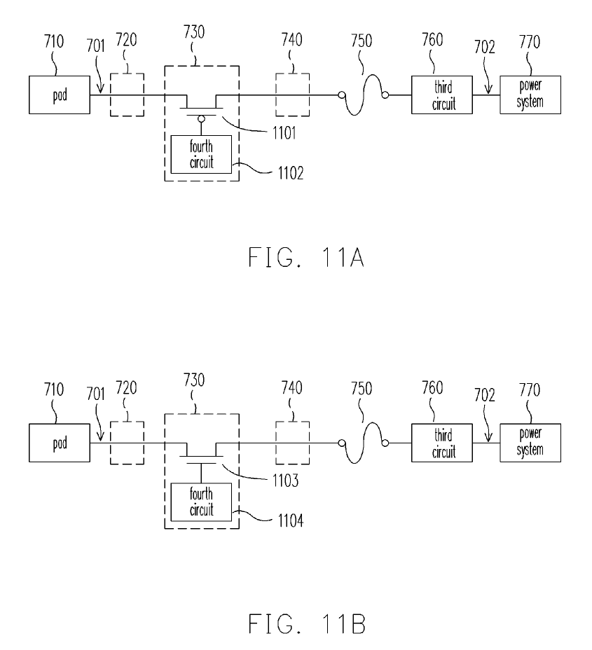

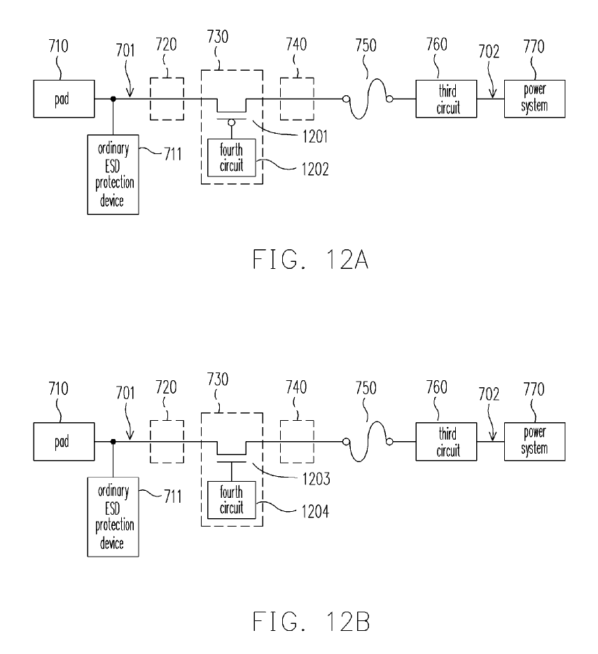

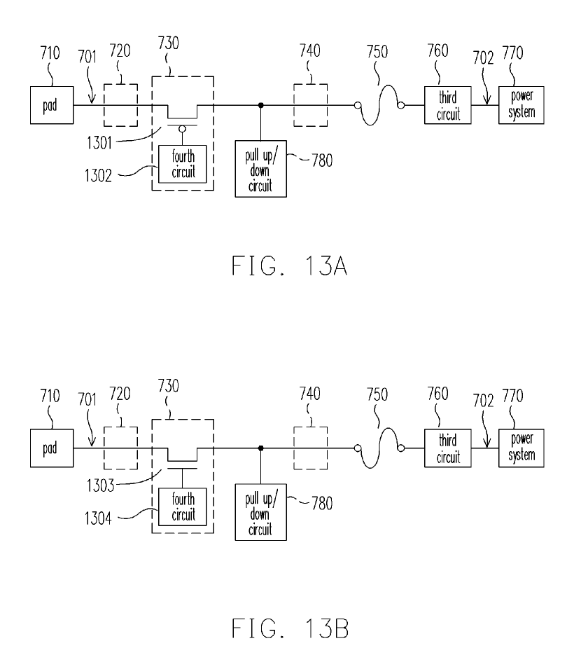

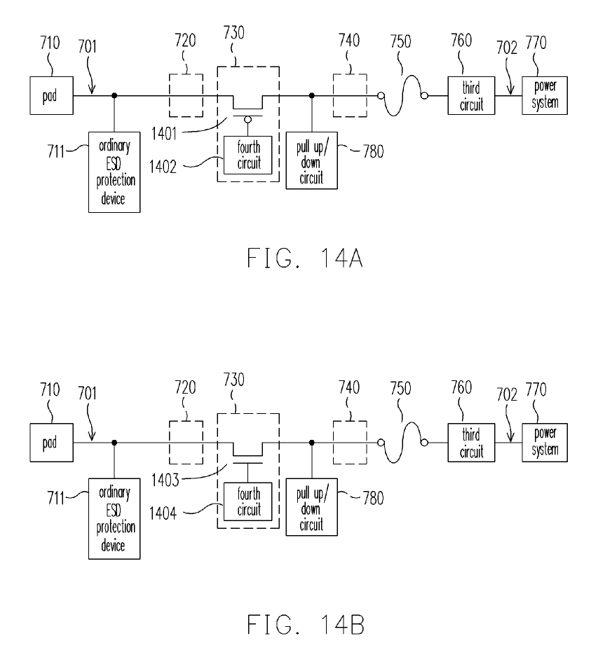

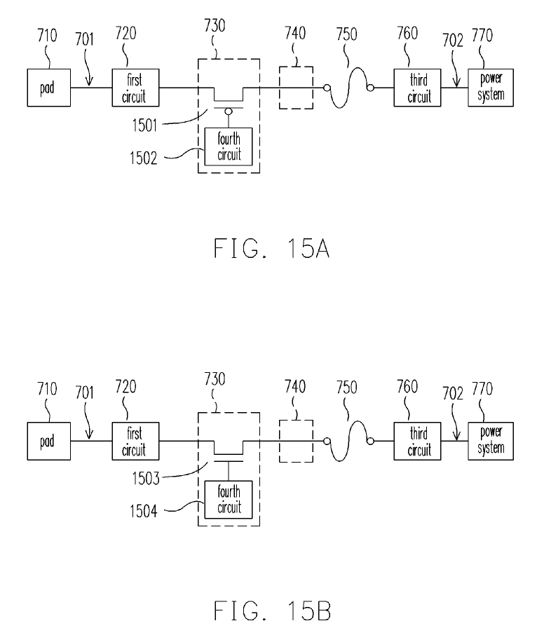

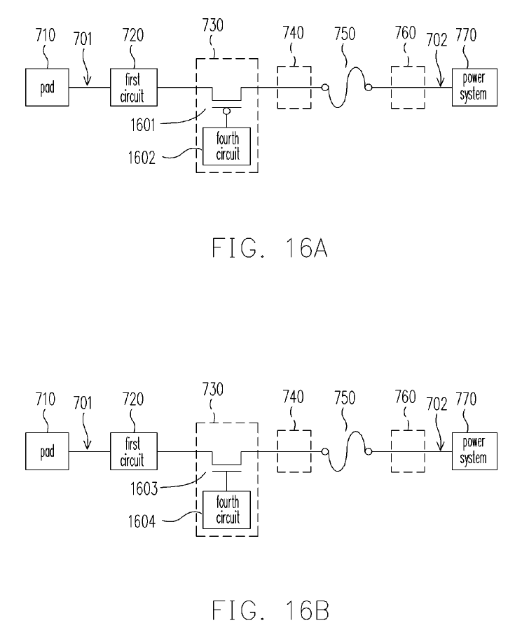

FIG. 9 is a block diagram of the ESD protection apparatus 900 for the programmable device according to the embodiment of the present invention. Referring to FIG. 9, the ESD protection apparatus 900 includes an eighth circuit 920, a ninth circuit 960, a first ESD protection unit 930, the second ESD protection unit 950 and a programmable device 940. In the present embodiment, a first node 901 and a second node 902 are electrically connected to a pad 910 and a power system 970, respectively. The power system 970 is decided as a power voltage wire, a ground voltage wire or the others as required by the designer.

The first and second ends of the eighth circuit 920 are electrically connected to the first node 901 and the first end of the first ESD protection unit 930, respectively. The programmable device 940 is used for recording the programming results, with its first and second ends electrically connected to the second end of the first ESD protection unit 930 and the first end of the second ESD protection unit 950, respectively. The first and second ends of the ninth circuit 960 are electrically connected to the second end of the second ESD protection unit 950 and the second node 902, respectively. The programmable device 940 is programmed by the eighth circuit 920 and the ninth circuit 960, and/or the programming results of the programmable device 940 is obtained by the eighth circuit 920 and the ninth circuit 960.

Generally, a conventional ESD protection device 911 is always disposed at the pad 910 in the design of the pad 910, in which the conventional ESD protection device 911 is coupled to the pad 910 (i.e. the first node 901). When the ESD has occurred, high impedances is provided by the first ESD protection unit 930 and the second ESD protection unit 950 to reduce the voltage drop between both ends of the programmable device 940, so that the programmable device 940 is protected from the damage deduced by the ESD event. Of course, the electrostatic discharge can be dissipated via the conventional ESD protection device 911, so as to reduce the electrostatic discharge which is flowed through the programmable device 94.

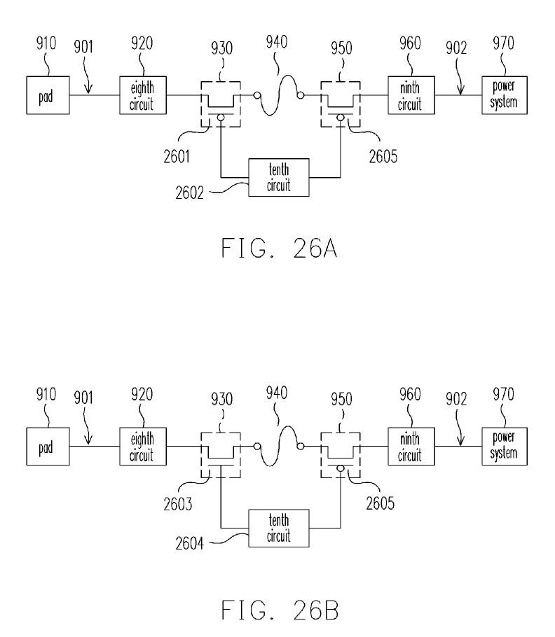

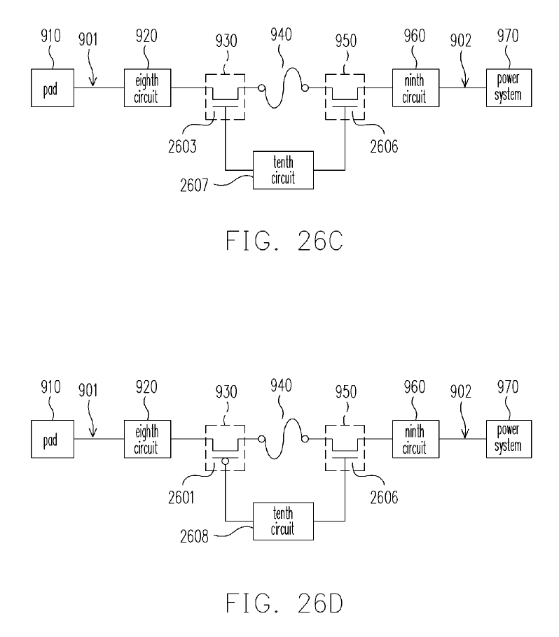

FIGS. 26A-28D respectively illustrate a plurality of embodiments of the ESD protection apparatus 900 in FIG. 9 according to the present invention. Referring to FIG. 26A, in the present embodiment, the first ESD protection unit 930 is implemented by the first transistor (herein referred to as a P-type transistor) 2601, and the second ESD protection unit 950 is implemented by the second transistor (herein referred to as a P-type transistor) 2605; and the programmable device 940 is implemented by the fuse. The tenth circuit 2602 controls the first transistor 2601 and the second transistor 2605. The programmable device 940 is programmed by the eighth circuit 920 and the ninth circuit 960, i.e. to determine whether the fuse should be blown. Alternatively, the state of the programmable device 940 is read by the eighth circuit 920 and the ninth circuit 960. The functions of the eighth circuit 920 and the ninth circuit 960 can be achieved by any means for those skilled in the art, and therefore there are no unnecessary details for the methods of carrying out the eighth circuit 920 and the ninth circuit 960. The first transistor 2601 and the second transistor 2605 are used as ESD protection devices, with their gates connected to the tenth circuit 2602. The source and drain of the first transistor 2601 are connected to the eighth circuit 920 and the programmable device 940, respectively. And the source and drain of the second transistor 2605 are connected to the programmable device 940 and the ninth circuit 960 respectively.

During the reading operation, the first transistor 2601 and the second transistor 2605 can be conducted through the control of the tenth circuit 2602. Meanwhile, the ninth circuit 960 is also conducted in preparation for the reading operation. The voltage drop between both ends of the programmable device 940 is sensed by the eighth circuit 920. If the programmable device 940 is blown, the detected voltage is surely not close to the level of the power system 970 (such as the ground voltage). If the programmable device 940 is not blown, the detected voltage is surely close to the level of the power system 970. And then, the eighth circuit 920 supplies the detected voltage to the secondary circuit (not shown), and the reading operation is completed. Additionally, if specially required, the first transistor 2601 and the second transistor 2605 can also be cut off through the control of the tenth circuit 2602, and thus the eighth circuit 920 can sense the information that the programmable device 940 (although the programmable device 940 is not blown actually) is blown and then output the information to the secondary circuit.

During the “blowing” operation, the external voltage is supplied to the programmable device 940 via the pad 910, and the first transistor 2601 and the second transistor 2605 are conducted through the control of the tenth circuit 2602. Meanwhile, the eighth circuit 920 and the ninth circuit 960 are also conducted in preparation for the writing operation. The eighth circuit 920, ninth circuit 960, the first transistor 2601 and the second transistor 2605 provide low impedances, so that a current path is formed from the pad 910 to the power system 970. Heat is produced when the current flows through the programmable device 940, and therefore the programmable device 940 is programmed as expected by blowing the wire.

During the ESD event, the first transistor 2601 and the second transistor 2605 provide high impedances to the current path from the pad 910 to power system 970. Since first transistor 2601 and the second transistor 2605 are connected in the current path in series, the electrostatic voltage is divided by the supplied high impedance. Therefore, the energy passed through the programmable device 940 resulting from the ESD event is reduced, so that the energy is lower than the voltage required by the “blowing” operation of the programmable device 940. Therefore, the programmable device 940 can maintain its original state, and ensure the accuracy of the data stored therein.

The functions of the tenth circuit 2602 described above can be achieved by any means. For example, the tenth circuit 2602 is implemented by the first wire lead; and both ends of the first wire lead are connected to the gate and the ground voltage wire of the first transistor 2601, respectively. And both ends of the second wire lead are connected to the gate and the ground voltage wire of the second transistor 2605, respectively. Furthermore, the implementations of the ESD protection units 930 and 950 are not limited to the method described above.

FIG. 26B illustrates another embodiment of the ESD protection apparatus 900 according to the present invention. FIG. 26B is similar to FIG. 26A, the difference resides in the first transistor 2603 implementing the N-type transistor in the ESD protection unit 930 of FIG. 26B. Being controlled by the tenth circuit 2604, the first transistor 2603 and the second transistor 2605 are conducted during the “blowing” operation, and the first transistor 2603 and the second transistor 2605 provide high impedances during the ESD event. The functions of the tenth circuit 2604 can be achieved by any means. For example, the tenth circuit 2604 is implemented by the first wire lead and the second wire lead, in which both ends of the first wire lead are connected to the gate and the power voltage wire of the first transistor 2603, respectively, and both ends of the second wire lead are connected to the gate and the ground voltage wire of the second transistor 2605, respectively.

FIG. 26C illustrates another embodiment of the ESD protection apparatus 900 according to the present invention. FIG. 26C is similar to FIG. 26A, the difference resides in the first transistor 2603 and the second transistor 2606 implementing the N-type transistor in the ESD protection unit 930 of FIG. 26C. Being controlled by the tenth circuit 2607, the first transistor 2603 and the second transistor 2606 are conducted during the “blowing” operation, and the first transistor 2603 and the second transistor 2606 provide high impedances during the ESD event. The functions of the tenth circuit 2607 can be achieved by any means. For example, the tenth circuit 2607 is implemented by the first wire lead and the second wire lead, in which both ends of the first wire lead are connected to the gate and the power voltage wire of the first transistor 2603, respectively, and both ends of the second wire lead are connected to the gate and the power voltage wire of the second transistor 2606, respectively.

FIG. 26D illustrates another embodiment of the ESD protection apparatus 900 according to the present invention. FIG. 26D is similar to FIG. 26A, the difference resides in the second transistor 2606 implementing the N-type transistor in the second ESD protection unit 930 of FIG. 26D. Being controlled by the tenth circuit 2608, the first transistor 2601 and the second transistor 2606 are conducted during the “blowing” operation, and the first transistor 2601 and the second transistor 2606 provide high impedances during the ESD event. The functions of the tenth circuit 2608 can be achieved by any means. For example, the tenth circuit 2608 is implemented by the first wire lead and the second wire lead, in which both ends of the first wire lead are connected to the gate and the ground voltage wire of the first transistor 2601, respectively, and both ends of the second wire lead are connected to the gate and the power voltage wire of the second transistor 2606, respectively.

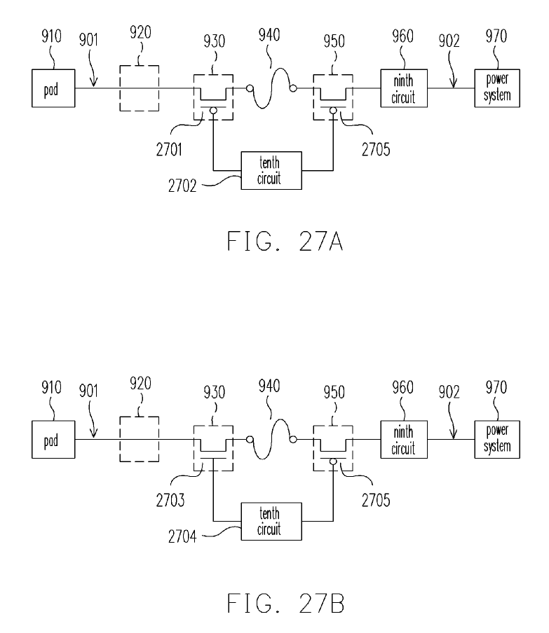

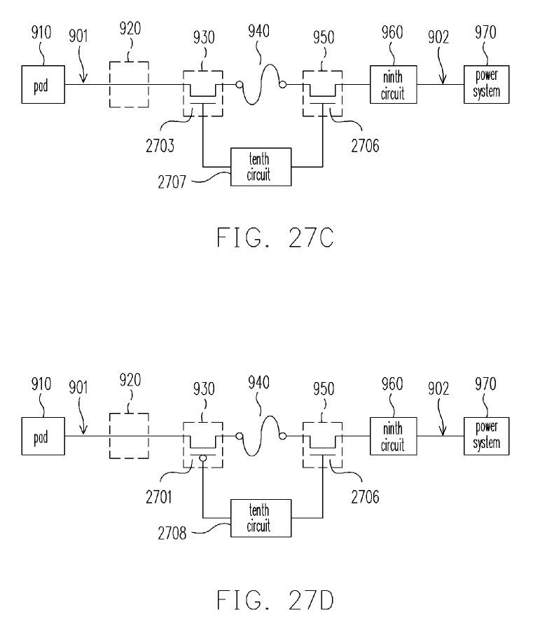

FIG. 27A illustrates another embodiment of the ESD protection apparatus 900 in FIG. 9 according to the present invention. Referring to FIG. 27A, in the present embodiment, the eighth circuit 920 is implemented by wire lead; the first ESD protection unit 930 is implemented by the first transistor (herein referred to as a P-type transistor) 2701; and the second ESD protection unit 950 is implemented by the second transistor (herein referred to as a P-type transistor) 2705; and the programmable device 940 is implemented by the fuse. The tenth circuit 2702 controls the first transistor 2701 and the second transistor 2705. The programmable device 940 is programmed by the ninth circuit 960, i.e. to determine whether the fuse should be blown. The functions of the ninth circuit 960 can be achieved by any means for those skilled in the art, and therefore there are no unnecessary details for the methods of carrying out the ninth circuit 960. The first transistor 2701 and the second transistor 2705 are used as ESD protection devices, with their gates connected to the tenth circuit 2702. The source and drain of the first transistor 2701 are connected to the pad 910 and the programmable device 940, respectively, and the source and drain of the second transistor 2705 are connected to the programmable device 940 and the ninth circuit 960, respectively.

During the reading operation, the first transistor 2701 and the second transistor 2705 can be conducted through the control of the tenth circuit 2702. Meanwhile, the ninth circuit 960 is also conducted, so as to facilitate the reading operation of the sensing circuit (not shown). Additionally, if specially required, the first transistor 2701 and the second transistor 2705 can also be cut off through the control of the tenth circuit 2702, and thus the sensing circuit (not shown) can sense the information that the programmable device 940 (although the programmable device 940 is not blown actually) is blown and then output the information to the secondary circuit.

During the “blowing” operation, the external voltage is supplied to the programmable device 940 via the pad 910, and the first transistor 2701 and the second transistor 2705 are conducted through the control of the tenth circuit 2702. Meanwhile, the ninth circuit 960 is also conducted in preparation for the writing operation. The ninth circuit 960, the first transistor 2701 and the second transistor 2705 all provide low impedances, so that a current path is formed from the pad 910 to the power system 970. Heat is produced when the current flows through the programmable device 940, and therefore the programmable device 940 is programmed as expected by blowing the wire.

During the ESD event, the first transistor 2701 and the second transistor 2705 provide high impedances to the current path from the pad 910 to power system 970. Since the first transistor 2701 and the second transistor 2705 are connected in the current path in series, the electrostatic voltage is divided by the supplied high impedance. Therefore, the energy passed through the programmable device 940 resulting from the ESD event is reduced, so that the energy is lower than the voltage required by the “blowing” operation of the programmable device 940. Therefore, the programmable device 940 can maintain its original state, and ensure the accuracy of the data stored therein.

The functions of the tenth circuit 2702 described above can be achieved by any means. For example, the tenth circuit 2702 is implemented by the first wire lead and the second wire lead, in which both ends of the first wire lead are connected to the gate and the ground voltage wire of the first transistor 2701, respectively. Both ends of the second wire lead are connected to the gate and the ground voltage wire of the second transistor 2705, respectively. Furthermore, the implementations of the ESD protection units 930 and 950 are not limited to the method described above.

FIG. 27B illustrates another embodiment of the ESD protection apparatus 900 according to the present invention. FIG. 27B is similar to FIG. 27A, the difference resides in the first transistor 2703 implementing the N-type transistor in the ESD protection unit 930 of FIG. 27B. Being controlled by the tenth circuit 2704, the first transistor 2703 and the second transistor 2705 are conducted during the “blowing” operation; and the first transistor 2703 and the second transistor 2705 provide high impedances during the ESD event. The functions of the tenth circuit 2704 can be achieved by any means. For example, the tenth circuit 2704 is implemented by the first wire lead and the second wire lead, in which both ends of the first wire lead are connected to the gate and the power voltage wire of the first transistor 2703, respectively, and both ends of the second wire lead are connected to the gate and the ground voltage wire of the second transistor 2705, respectively.

FIG. 27C illustrates another embodiment of the ESD protection apparatus 900 according to the present invention. FIG. 27C is similar to FIG. 27A, the difference resides in the first transistor 2703 and the second transistor 2706 implementing the N-type transistor in the ESD protection unit 930 of FIG. 27C. Being controlled by the tenth circuit 2707, the first transistor 2703 and the second transistor 2706 are conducted during the “blowing” operation, and the first transistor 2703 and the second transistor 2706 provide high impedances during the ESD event. The functions of the tenth circuit 2707 can be achieved by any means. For example, the tenth circuit 2707 is implemented by the first wire lead and the second wire lead, in which both ends of the first wire lead are connected to the gate and the power voltage wire of the first transistor 2703, respectively, and both ends of the second wire lead are connected to the gate and the power voltage wire of the second transistor 2706, respectively.

FIG. 27D illustrates another embodiment of the ESD protection apparatus 900 according to the present invention. FIG. 27D is similar to FIG. 27A, the difference resides in the second transistor 2706 implementing the N-type transistor in the second ESD protection unit 930 of FIG. 27D. Being controlled by the tenth circuit 2708, the first transistor 2701 and the second transistor 2706 are conducted during the “blowing” operation, and the first transistor 2701 and the second transistor 2706 provide high impedances during the ESD event. The functions of the tenth circuit 2708 can be achieved by any means. For example, the tenth circuit 2708 is implemented by the first wire lead and the second wire lead, in which both ends of the first wire lead are connected to the gate and the ground voltage wire of the first transistor 2701, respectively, and both ends of the second wire lead are connected to the gate and the power voltage wire of the second transistor 2706, respectively.

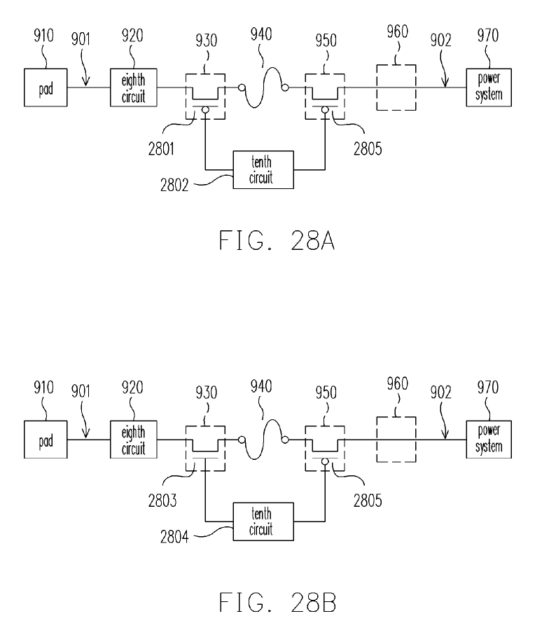

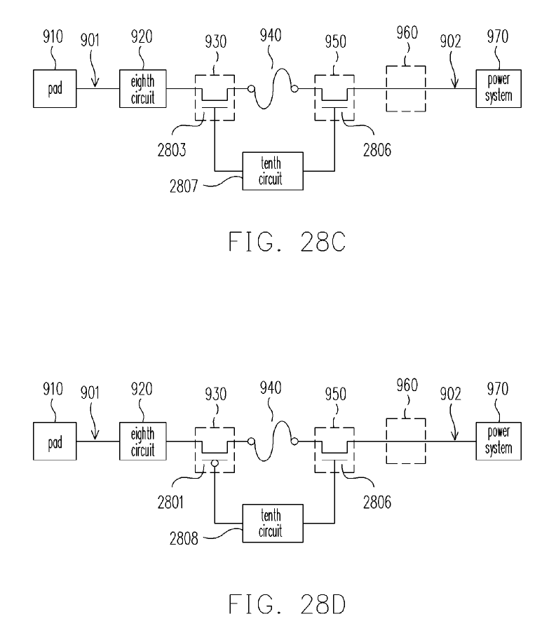

FIG. 28A illustrates another embodiment of the ESD protection apparatus 900 in FIG. 9 according to the present invention. Referring to FIG. 28A, in the present embodiment, the ninth circuit 960 is implemented by wire lead; the first ESD protection unit 930 is implemented by the first transistor (herein referred to as a P-type transistor) 2801; and the second ESD protection unit 950 is implemented by the second transistor (herein referred to as a P-type transistor) 2805; and the programmable device 940 is implemented by the fuse. The tenth circuit 2802 controls the first transistor 2801 and the second transistor 2805. The programmable device 940 is programmed by the eighth circuit 920, i.e. to determine whether the fuse should be blown. Alternatively, the state of the programmable device 940 is read by the eighth circuit 920. The functions of the eighth circuit 920 can be achieved by any means for those skilled in the art, and therefore the embodiments implementing the eighth circuit 920 are not illustrated herein. The first transistor 2801 and the second transistor 2805 are used as the ESD protection devices with their gates connected to the tenth circuit 2802. The source and drain of the first transistor 2801 are connected to the eighth circuit 920 and the programmable device 940, respectively, and the source and drain of the second transistor 2705 are connected to the programmable device 940 and the power system 970, respectively.

During the reading operation, the first transistor 2801 and the second transistor 2805 can be conducted through the control of the tenth circuit 2802. The voltage drop between both ends of the programmable device 940 is sensed by the eighth circuit 920. If the programmable device 940 is blown, the detected voltage is surely not close to the level of the power system 970. If the programmable device 940 is not blown, the detected voltage is surely close to the level of the power system 970. And then, the eighth circuit 920 supplies the detected voltage to the secondary circuit (not shown), and the reading operation is completed. Additionally, if specially required, the first transistor 2801 and the second transistor 2805 can also be cut off through the control of the tenth circuit 2802, and thus the eighth circuit 920 can sense the information that the programmable device 940 (although the programmable device 940 is not blown actually) is blown and then output the information to the secondary circuit.

During the “blowing” operation, the external voltage is supplied to the programmable device 940 via the pad 910, and the first transistor 2801 and the second transistor 2805 are conducted through the control of the tenth circuit 2802. Meanwhile, the eighth circuit 920 is also conducted in preparation for the writing operation. The eighth circuit 920, the first transistor 2801 and the second transistor 2805 all provide low impedances, so that a current path is formed from the pad 910 to the power system 970. Heat is produced when the current flows through the programmable device 940, and therefore the programmable device 940 is programmed as expected by blowing the wire.

During the ESD event, the first transistor 2801 and the second transistor 2805 provide high impedances to the current path from the pad 910 to the power system 970. Since the first transistor 2801 and the second transistor 2805 are connected in the current path in series, the electrostatic voltage is divided by the supplied high impedance. Therefore, the energy passed through the programmable device 940 resulting from the ESD event is reduced, so that the energy is lower than the voltage required by the “blowing” operation of the programmable device 940. Therefore, the programmable device 940 can maintain its original state, and ensure the accuracy of the data stored therein.

The functions of the tenth circuit 2802 described above can be achieved by any means. For example, the tenth circuit 2802 is implemented by the first wire lead and the second wire lead, in which both ends of the first wire lead are connected to the gate and the ground voltage wire of the first transistor 2801, respectively. Both ends of the second wire lead are connected to the gate and the ground voltage wire of the second transistor 2805, respectively. Furthermore, the implementations of the ESD protection units 930 and 950 are not limited to the method described above.

FIG. 28B illustrates another embodiment of the ESD protection apparatus 900 according to the present invention. FIG. 28B is similar to FIG. 28A, the difference resides in the first transistor 2803 implementing the N-type transistor in the ESD protection unit 930 of FIG. 28B. Being controlled by the tenth circuit 2804, the first transistor 2803 and the second transistor 2805 are conducted during the “blowing” operation, and the first transistor 2803 and the second transistor 2805 provide high impedances during the ESD event. The functions of the tenth circuit 2804 can be achieved by any means. For example, the tenth circuit 2804 is implemented by the first wire lead and the second wire lead, in which both ends of the first wire lead are connected to the gate and the power voltage wire of the first transistor 2803, respectively, and both ends of the second wire lead are connected to the gate and the ground voltage wire of the second transistor 2805, respectively.

FIG. 28C illustrates another embodiment of the ESD protection apparatus 900 according to the present invention. FIG. 28C is similar to FIG. 28A, the difference resides in the first transistor 2803 and the second transistor 2806 implementing the N-type transistor in the ESD protection unit 930 of FIG. 28C. Being controlled by the tenth circuit 2807, the first transistor 2803 and the second transistor 2806 are conducted during the “blowing” operation, and the first transistor 2803 and the second transistor 2806 provide high impedances during the ESD event. The functions of the tenth circuit 2807 can be achieved by any means. For example, the tenth circuit 2807 is implemented by the first wire lead and the second wire lead, in which both ends of the first wire lead are connected to the gate and the power voltage wire of the first transistor 2803, respectively, and both ends of the second wire lead are connected to the gate and the power voltage wire of the second transistor 2806, respectively.

FIG. 28D illustrates another embodiment of the ESD protection apparatus 900 according to the present invention. FIG. 28D is similar to FIG. 28A, the difference resides in the second transistor 2806 implementing the N-type transistor in the second ESD protection unit 930 of FIG. 28D. Being controlled by the tenth circuit 2808, the first transistor 2801 and the second transistor 2806 are conducted during the “blowing” operation, and the first transistor 2801 and the second transistor 2806 provide high impedances during the ESD event. The functions of the tenth circuit 2808 can be achieved by any means. For example, the tenth circuit 2808 is implemented by the first wire lead and the second wire lead, in which both ends of the first wire lead are connected to the gate and the ground voltage wire of the first transistor 2801, respectively, and both ends of the second wire lead are connected to the gate and the power voltage wire of the second transistor 2806, respectively.

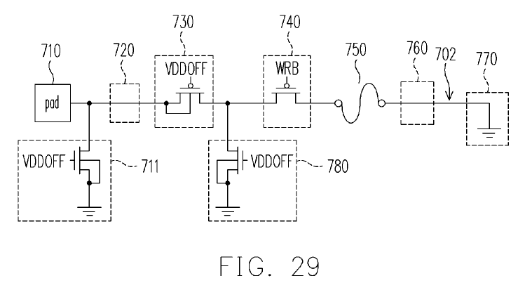

FIG. 29 illustrates a circuit diagram of another embodiment of the ESD protection apparatus 700 in the FIG. 7 according to the present invention. Referring to FIG. 29, the first circuit 720 and third circuit 760 are implemented by wire leads; and the ESD protection unit 730 is implemented by the first transistor (here referred to as the P-type transistor) 2901; and the programmable device 750 is implemented by the fuse. Generally, a conventional ESD protection device 711 is mostly disposed at the pad 710 in the design of the pad 710, so that the internal circuits is protected from the damage deduced by the ESD event in the pad 710. It is much common to dispose an ESD protection device in the pad device for the ordinary integrated circuits.

When writing the data, the p-type transistor 2901 is conducted and the conventional ESD protection device 711 and the pull/down circuit 780 is cut off by the control signal VDDOFF. Meanwhile, the second circuit 740 is conducted by the control signal WRB. And now, whether the programmable device 750 is blown is determined based upon whether the pad 710 is provided with the external power or not, and this is called as programming operation. If the external power is supplied to the pad 710, the external power will flow from the pad 710 through the ESD protection unit 730, second circuit 740 and the programmable device 750 to the power system 770 (as the ground voltage wire in the present embodiment). The current which is flowed through the programmable device 750 is to blow the fuse as the heat is produced.

After the programming operation, the control circuit (not shown) can cut off the ESD protection unit 730 by the control signal VDDOFF, so as to cut the connection between the programmable device 750 and the pad 710. And now, the pull up/down circuit 780 is used to pull down the voltage level, so that the determination on the state of the programmable device shall not be affected by any unexpected signals due to circuit floating. Additionally, if specially required, the read state (rather than the real state) of the programmable device 750 can also be changed by using the functions of the ESD protection unit 730. The sensing circuit (not shown) can obtain the changed read state of the programmable device 750, i.e. the state is changed from the short circuit to the open circuit. For the one time writing programmable device, this function can provide a more flexible application.

In view of the above, since an ESD protection unit is disposed in the electric path of the programmable device, when the ESD event has occurred, the ESD protection unit will share most of the voltage drop owing to the high impedance, so that the voltage drop of the programmable device can be reduced to a tolerable level, and the present invention has a preferable ESD protection performance.

The present invention has been disclosed above in the preferred embodiments, but is not limited to those. It is known to persons skilled in the art that some modifications and innovations can be made without departing from the spirit and scope of the present invention. Therefore, the scope of the present invention should be defined by the following claims.

What is claimed is:

1. An electrostatic discharge (ESD) protection apparatus for the programmable device, comprising:
a first circuit, wherein the first end electrically connected to a first node;
an ESD protection unit, wherein the first end electrically connected to the second end of the first circuit;
a second circuit, wherein the first end electrically connected to the second end of the ESD protection unit;
a programmable device, having a first end and a second end for recording the programming results, wherein the first end of the programmable device is electrically connected to the second end of the second circuit; and
a third circuit, with the first end and the second end electrically connected to the second end of the programmable device and a second node, respectively,
wherein the programmable device is programmed using the first circuit, the second circuit, and the third circuit, and/or the programming results of the programmable device are obtained using the first circuit, the second circuit, and the third circuit; and
when the ESD has occurred, the ESD protection unit provides a high impedance to prevent the programmable device away from the damage induced by the electrostatic discharge.

2. The ESD protection apparatus for the programmable device as claimed in claim 1, wherein the first circuit comprises a wire lead, and the first end and the second end of the wire lead are electrically connected to the first node and the first end of the ESD protection unit, respectively.

3. The ESD protection apparatus for the programmable device as claimed in claim 1, wherein the second circuit comprises a wire lead, and the first end and the second end of the wire lead are electrically connected to the second end of the ESD protection unit and the first end of the programmable device, respectively.

4. The ESD protection apparatus for the programmable device as claimed in claim 1, wherein the third circuit comprises a wire lead, and the first end and the second end of the wire lead are electrically connected to the second end of the programmable device and the second node, respectively.

5. The ESD protection apparatus for the programmable device as claimed in claim 1, wherein the programmable device is a fuse.

6. The ESD protection apparatus for the programmable device as claimed in claim 1, wherein the first node is coupled to a pad, and the second node is coupled to a power voltage wire.

7. The ESD protection apparatus for the programmable device as claimed in claim 1, wherein the first node is coupled to a pad, and the second node is coupled to a ground voltage wire.

8. The ESD protection apparatus for the programmable device as claimed in claim 1, wherein the ESD protection unit comprising:
a first transistor, wherein the source and drain coupled to the second end of the first circuit and the first end of the second circuit, respectively;
a fourth circuit coupled to the gate of the first transistor for controlling the ESD protection unit to provide a high impedance or not.

9. The ESD protection apparatus for the programmable device as claimed in claim 8, wherein the first transistor is a P-type transistor.

10. The ESD protection apparatus for the programmable device as claimed in claim 9, wherein the fourth circuit comprises a first wire lead, and both ends of the first wire lead are connected to the gate of the first transistor and a ground voltage wire, respectively.

11. The ESD protection apparatus for the programmable device as claimed in claim 8, wherein the first transistor is an N-type transistor.

12. The ESD protection apparatus for the programmable device as claimed in claim 11, wherein the fourth circuit comprises a first wire lead, and both ends of the first wire lead are connected to the gate of the first transistor and a power voltage wire, respectively.

13. The ESD protection apparatus for the programmable device as claimed in claim 8, wherein the ESD protection unit further comprises a second transistor, and the first transistor and the second transistor are connected in series between the second end of the first circuit and the first end of the second circuit,
wherein the fourth circuit is electrically connected to the gate of the first transistor and the gate of the second transistor for controlling the ESD protection unit to provide a high impedance or not.

14. The ESD protection apparatus for the programmable device as claimed in claim 13, wherein the second transistor is a P-type transistor.

15. The ESD protection apparatus for the programmable device as claimed in claim 14, wherein the fourth circuit comprises a second wire lead, and both ends of the second wire lead are connected to the gate of the second transistor and a ground voltage wire, respectively.

16. The ESD protection apparatus for the programmable device as claimed in claim 13, wherein the second transistor is an N-type transistor.

17. The ESD protection apparatus for the programmable device as claimed in claim 16, wherein the fourth circuit comprises a second wire lead, and both ends of the second wire lead are connected to the gate of the second transistor and a power voltage wire, respectively.

18. The ESD protection apparatus for the programmable device as claimed in claim 1, further comprising a pull up/down circuit electrically connected to the second end of the ESD protection unit.

19. The ESD protection apparatus for the programmable device as claimed in claim 1, wherein the first node is electrically connected to a pad, and the pad having an ESD protection device coupled to the first node.

20. An ESD protection apparatus for the programmable device, comprising:
a fifth circuit, wherein the first end electrically connected to a first node;
a programmable device having a first end and a second end for recording the programming results, wherein the first end of the programmable device is electrically connected to a second end of the fifth circuit;
an ESD protection unit, wherein the first end electrically connected to the second end of the programmable device; and
a sixth circuit, wherein the first end and the second end electrically connected to the second end of the ESD protection unit and a second node, respectively,
wherein the programmable device is programmed by the fifth circuit and/or the sixth circuit, and/or the programming results of the programmable device are obtained by the fifth circuit and/or the sixth circuit; and
when the ESD has occurred, the ESD protection unit provides a high impedance to prevent the programmable device away from the damage induced by the electrostatic discharge.

21. The ESD protection apparatus for the programmable device as claimed in claim 20, wherein the fifth circuit comprises a wire lead, and the first and second ends of the wire lead are electrically connected to the first node and the first end of the programmable device, respectively.

22. The ESD protection apparatus for the programmable device as claimed in claim 20, wherein the sixth circuit comprises a wire lead, and the first and second ends of the wire lead are electrically connected to the second end of the ESD protection unit and the second node, respectively.

23. The ESD protection apparatus for the programmable device as claimed in claim 20, wherein the programmable device is a fuse.

24. The ESD protection apparatus for the programmable device as claimed in claim 20, wherein the first node is coupled to a pad, and the second node is coupled to a power voltage wire.

25. The ESD protection apparatus for the programmable device as claimed in claim 20, wherein the first node is coupled to a pad, and the second node is coupled to a ground voltage wire.

26. The ESD protection apparatus for the programmable device as claimed in claim 20, wherein the ESD protection unit comprises:
a first transistor, with source and drain coupled to the second end of the programmable device and the first end of the sixth circuit, respectively;
a seventh circuit coupled to the gate of the first transistor for controlling the ESD protection unit to provide a high impedance or not.

27. The ESD protection apparatus for the programmable device as claimed in claim 26, wherein the first transistor is a P-type transistor.

28. The ESD protection apparatus for the programmable device as claimed in claim 27, wherein the seventh circuit comprises a first wire lead, and both ends of the first wire lead are connected to the gate of the first transistor and a ground voltage wire, respectively.

29. The ESD protection apparatus for the programmable device as claimed in claim 26, wherein the first transistor is an N-type transistor.

30. The ESD protection apparatus for the programmable device as claimed in claim 29, wherein the seventh circuit comprises a first wire lead, and both ends of the first wire lead are connected to the gate of the first transistor and a power voltage wire, respectively.

31. The ESD protection apparatus for the programmable device as claimed in claim 26, wherein the ESD protection unit further comprises a second transistor, wherein the first transistor and the second transistor are connected in series between the second end of the programmable device and the first end of the sixth circuit;
wherein the fourth circuit is electrically connected to the gate of the first transistor and the gate of the second transistor for controlling the ESD protection unit to provide a high impedance or not.

32. The ESD protection apparatus for the programmable device as claimed in claim 31, wherein the second transistor is a P-type transistor.

33. The ESD protection apparatus for the programmable device as claimed in claim 32, wherein the seventh circuit comprises a second wire lead, and both ends of the second wire lead are connected to the gate of the second transistor and a ground voltage wire, respectively.

34. The ESD protection apparatus for the programmable device as claimed in claim 31, wherein the second transistor is an N-type transistor.

35. The ESD protection apparatus for the programmable device as claimed in claim 34, wherein the seventh circuit comprises a second wire lead, and both ends of the second wire lead are connected to the gate of the second transistor and a power voltage wire, respectively.

36. The ESD protection apparatus for the programmable device as claimed in claim 20, wherein the first node is electrically connected to a pad, and the pad is provided with an ESD protection device, wherein the ESD protection device is coupled to the first node.

37. An ESD protection apparatus for the programmable device, comprising:
an eighth circuit, wherein the first end electrically connected to a first node;
a first ESD protection unit, wherein the first end electrically connected to the second end of the eighth circuit;
a programmable device having a first end and a second end for recording the programming results, wherein the first end of the programmable device is electrically connected to a second end of the first ESD protection unit;
a second ESD protection unit, wherein the first end electrically connected to the second end of the programmable device; and
a ninth circuit, wherein the first end and the second end electrically connected to the second end of the second ESD protection unit and a second node, and
the programmable device is programmed by the eighth circuit and/or the ninth circuit, and/or the programming results of the programmable device are obtained by the eighth circuit and/or the ninth circuit; and
when the ESD has occurred, the first and second ESD protection units provide high impedances to prevent the programmable device from damages induced by the electrostatic discharge.

38. The ESD protection apparatus for the programmable device as claimed in claim 37, wherein the eighth circuit comprises a wire lead, and the first and second ends of the wire lead are electrically connected to the first node and the first end of the first ESD protection unit, respectively.

39. The ESD protection apparatus for the programmable device as claimed in claim 37, wherein the ninth circuit comprises a wire lead, and the first end and the second end of the wire lead are electrically connected to the second end of the second ESD protection unit and the second node, respectively.

40. The ESD protection apparatus for the programmable device as claimed in claim 37, wherein the programmable device is a fuse.

41. The ESD protection apparatus for the programmable device as claimed in claim 37, wherein the first node is coupled to a pad, and the second node is coupled to a power voltage wire.

42. The ESD protection apparatus for the programmable device as claimed in claim 37, wherein the first node is coupled to a pad, and the second node is coupled to a ground voltage wire.

43. The ESD protection apparatus for the programmable device as claimed in claim 37, further comprising a tenth circuit, wherein
the first ESD protection unit includes a first transistor, and the drain and source of the first transistor are coupled to the second end of the eighth circuit and the first end of the programmable device, respectively, and the gate of the first transistor is electrically connected to the tenth circuit;
the second ESD protection unit includes a second transistor, and the drain and source of the second transistor are coupled to the second end of the programmable device and the first end of the ninth circuit, respectively, and the gate of the second transistor is electrically connected to the tenth circuit; and
the tenth circuit is used for controlling the first and second ESD protection units to provide a high impedances or not.

44. The ESD protection apparatus for the programmable device as claimed in claim 43, wherein the first transistor is a P-type transistor, and the tenth circuit comprises a first wire lead, and both ends of the first wire lead are connected to the gate of the first transistor and a ground voltage wire, respectively.

45. The ESD protection apparatus for the programmable device as claimed in claim 43, wherein the first transistor is an N-type transistor, and the tenth circuit comprises a first wire lead, and both ends of the first wire lead are connected to the gate of the first transistor and a power voltage wire, respectively.

46. The ESD protection apparatus for the programmable device as claimed in claim 43, wherein the second transistor is a P-type transistor, and the tenth circuit comprises a second wire lead, and both ends of the second wire lead are connected to the gate of the second transistor and a ground voltage wire, respectively.

47. The ESD protection apparatus for the programmable device as claimed in claim 43, wherein the second transistor is an N-type transistor, and the tenth circuit comprises a second wire lead, and both ends of the second wire lead are connected to the gate of the second transistor and a power voltage wire, respectively.

48. The ESD protection apparatus for the programmable device as claimed in claim 37, wherein the first node is electrically connected to a pad, and the pad having an ESD protection device coupled to the first node.
